(19) United States
(12) Patent Application Publication
(10) Pub. No.: US 2002/0161803 A1
(43) Pub. Date: Oct. 31, 2002

(54) Web page color accuracy

(75) Inventor: Richard M. Shelton, Roseville, MN (US)

Correspondence Address: Attention: William D. Bauer, Imation Corp., Legal Affairs, P.O. Box 64898, St. Paul, MN, 55164-0898, US

(73) Assignee: Imation Corp.

(21) Appl. No.: 09/809,654

(22) Filed: Mar. 15, 2001

(51) Int. Cl. G06F 17/21

(52) U.S. Cl. 707/528; 707/526

(57) ABSTRACT

Improved color image display accuracy can be achieved across a computer network by obtaining information characterizing the color response of display devices associated with a client residing on the computer network, and using the information to modify text files defining color values for presentation of objects in web pages. Display accuracy can be achieved in a network having multiple clients that receive images. The information can be obtained, for example, by guiding clients that download images or other visual content through a color profiling process that profiles the color response of the display device. For example, such guidance may take the form of a series of instructional web pages that are delivered to the client. The web pages can be made interactive to enable collection of color characterization data from the client.

### TECHNICAL FIELD

The invention relates to color imaging and, more particularly, to presentation of color images on display devices.

### BACKGROUND

The growth of the Internet has created sizable opportunities for online retailers. Most major retailers of consumer products have established commercial sites on the World Wide Web. At the same time, the availability of web site presence has eliminated many of the marketing barriers previously experienced by smaller retailers. Virtually any retailer can now post product information for easy access by potential customers, and take orders for its products in an automated fashion.

The product information may include a large number of images. The images enable web customers situated at client devices to view products before submitting an online purchase order. For some items, the user is permitted to click on a “thumbnail” image to view the item in a higher resolution format. In many cases, however, the quality of the images can be a significant concern. Color accuracy, in particular, can be very important for products for which color is a major selling point.

In the case of clothing retailers, for example, an image of a sweater should match its actual color as closely as possible. Unfortunately, the color output characteristics of different display devices can differ significantly. A cathode ray tube (CRT) or flat panel display, video card, driver software, and operating system together determine how red, green, and blue (RGB) pixel values will be rendered and displayed, and vary significantly from system to system.

Consequently, an online customer may order what appears to be a burgundy sweater but instead receive a bright red sweater. Indeed, color inaccuracy has become a significant cause for return of merchandise purchased by online customers. In some cases, this problem can erase the advantages obtained by a seller's commitment to online merchandising, and undermine continued investment.

### SUMMARY

The invention is directed to improvement of color image display accuracy in a computer network having display devices with different color output characteristics. The invention improves color accuracy in web pages by modification of color references within a text file, such as an HTML file, Java script, or style sheet, according to the color response characteristics of the display devices used by network clients.

In particular, the invention sets color values in the text file to produce web page objects with greater color accuracy. In some embodiments, the invention also sets the colors of images tagged within the web pages based on the color response characteristics of the display devices. In this manner, web page color can be personalized or customized for the display device characteristics of individual users.

An HTML file or Java script defines color, layout, and other characteristics of a web page. The HTML also may refer to a style sheet that resides within or external to an HTML file. Examples of style sheets currently in use include Extensible Style Language (XSL) and Cascading Style Sheet (CSS) style sheets. The HTML files, scripts, and style sheets may refer to a relatively short list of default colors or specify custom RGB values for assignment to objects within the web page. When a web browser assembles a web page, it interprets the web page HTML, scripts, and style sheet code. In particular, the web browser interprets HTML and other commands to place objects within a web page and assign them particular colors.

By modifying the color commands according to the color response characteristics of a particular display device, the invention permits assignment of more accurate color values to the web page objects. The invention enables customization of web page content to compensate for color response differences among various display devices. The web pages and scripts communicated to individual clients contain color commands formulated for the display devices of those clients, and thereby assign customized colors to the objects within the page, promoting increased color accuracy.

The invention may involve a color profiling process that determines the color response characteristics of individual display devices. The color values in the customized text files can be based on results of the color profiling process. Determination of color profiles for individual network clients enables the delivery of web page content with improved color accuracy, providing online retailers and consumers with greater confidence.

In one embodiment, the invention provides a method comprising formulating a text file containing color commands for presentation of objects within a web page based on a color response of a display device associated with a client on a computer network, and communicating the text file via the computer network.

In another embodiment, the invention provides a computer-readable medium containing instructions that cause a programmable processor to formulate a text file containing color commands for presentation of objects within a web page based on a color response of a display device associated with a client on a computer network, and communicate the text file via the computer network.

In an added embodiment, the invention provides a system comprising a color correction module that formulates a text file containing color commands for presentation of objects within a web page for a web page based on a color response of a display device associated with a client on a computer network.

The details of one or more embodiments of the present invention are set forth in the accompanying drawings and the description below. Other features, objects, and advantages of the present invention will be apparent from the description and drawings, and from the claims.

### BRIEF DESCRIPTION OF THE DRAWINGS

FIG. 1 is a block diagram of a system for serving color-customized web pages;

FIG. 2 is a block diagram of a web-based environment incorporating a system as shown in FIG. 1;

FIG. 3 is a flow diagram illustrating a process for serving color-customized web pages;

FIG. 4 is a flow diagram illustrating a process for serving color-customized web pages and profiling the color responses of display devices associated with network clients;

FIG. 5 is a flow diagram illustrating a color profiling process for a display device associated with a network client;

FIG. 6 is a block diagram illustrating a system for serving color-customized web pages in greater detail;

FIG. 7 is a flow diagram illustrating a process for serving web pages with color-customization of web page objects and tagged images;

FIG. 8 is a flow diagram illustrating a multi-channel blackpoint determination in a color profiling process;

FIG. 9 is a diagram of a web page for analog adjustment of a color display prior to blackpoint determination;

FIG. 10 is a diagram of a web page for determination of blackpoint for a particular color channel;

FIG. 11 is a flow diagram illustrating gamma and gray balance determination in a color profiling process;

FIG. 12 illustrates a range of gray elements for use in determining a coarse gamma in a color profiling process;

FIG. 13 illustrates a range of gray elements for use in determining a fine gamma in a color profiling process;

FIG. 14 illustrates a range of gray elements for use in determining gray balance in a color profiling process; and

FIG. 15 is a block diagram illustrating transmission of color correction information in a system as shown in FIGS. 1 and 2.

### DETAILED DESCRIPTION

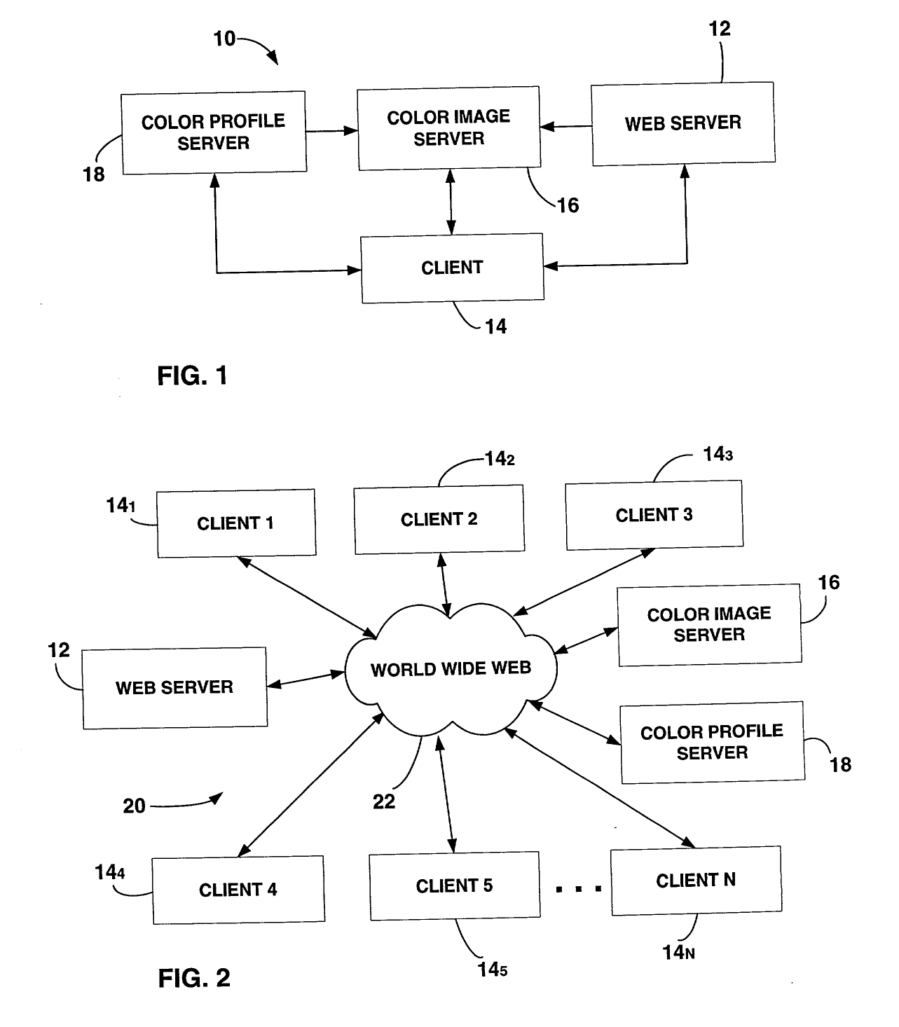

FIG. 1 is a block diagram of a system 10 for improving color image display accuracy across a computer network. The computer network may take the form of a local area network, wide area network, or global computer network such as the World Wide Web. As shown in FIG. 1, system 10 may include a web server 12, a client 14, a color image server 16, and a color profile server 18. Servers 12, 16, 18 may be integrated and managed as a common network domain, or provided as independent servers that communicate over the network.

Web server 12 communicates web pages to client 14 upon request. The web pages may include web page objects and tagged images. Web page objects may include text, tables, boxes, and the like. In one embodiment, web server 12 may redirect clients 14 to color image server 16 for color-customized, or “corrected,” web pages that are configured according to the characteristics of particular display devices associated with the clients.

Color image server 16 may communicate color-customized web pages including color commands that are modified based on the calorimetric characteristics of display devices associated with clients 14. The tagged images also may be stored on color image server 16. Color image server 16 also may store style sheets, scripts, and other text files for web pages served by web server 12, whether the web pages are stored by color image server 16 or elsewhere. Alternatively, in some embodiments, all of the style sheets and web pages may be stored at web server 12, without the need for redirection to color image server 16.

The color commands may be provided in web pages or Java script, as well as internal or external style sheets. The color commands determine color and other characteristics of the objects presented in the web page. As examples, the style sheets may be Extensible Style Language (XSL) or Cascading Style Sheet (CSS) style sheets. The web pages may be HTML or XML, and may reference the style sheets and tagged images for assembly of content within a web browser at client 14. In some cases, the web pages may reference multiple style sheets. The web browser at a client 14 interprets the color commands set forth in the web page to control placement of objects within the web page and assign particular colors to them.

System 10 may be arranged in a variety of different configurations. In one configuration, default web pages that are not configured for color customization are stored at web server 12. Web server 12 may provide an online presence for a web retailer or other entity concerned about color accuracy. Instead of storing default web pages that are not color customized, the web pages at web server 12 may simply provide redirects to corresponding web pages on another server such as color image server 16, which is responsible for color customization or “correction.” In that case, color image server 16 may be responsible for serving color-customized web pages in the event client 14 requests, them or default web pages in the event the client does not. Any scripts that may be associated with the web pages also can be handled by color image server 16.

Style sheets and tagged images referenced by the web pages also may be stored at color image server 16. In this manner, the style sheets and tagged images are also stored at an entity responsible for color customization, i.e., the color image server 16. Color image server 16 receives requests for web pages, style sheets and tagged images invoked by redirects or other web pages communicated by web server 12. In some embodiments, the color correction functionality may be integrated with web server 12, such that web pages, scripts, tagged images, and style sheets are all handled by the same server, and there is no need for a separate color image server 16. In many cases, however, it will be desirable to provide the color correction functionality on a separate server, e.g., color image server 16.

Thus, in some configurations, the web pages communicated by web server 12 may simply redirect client 14 to color image server 16 for access to web page content in the event color correction is desired. All of the content to be color corrected can be stored at color image server 16, while content that is not color corrected can be stored at web server 12. In this case, web server 12 may only serve content that is not color corrected, and provide redirects to color image server 16 when color corrected content is necessary.

In one embodiment, a color correction module formulates text files such as web pages, scripts, and style sheets that define web objects based on color response characteristics of a display device associated with client 14. The color correction module may execute on web server 12, color image server 16, color profile server 18 or elsewhere. The color correction module sets color values within the text files. In some embodiments, the color correction module also sets the color values of tagged images served by color image server based on the color response characteristics of the display device associated with client 14.

The color correction module accesses the text files to color-customize web objects for client 14. By setting color values for the text files and the tagged images, client 14 receives web pages that are color-customized for greater accuracy. For color-customization, the color correction module may access color profiles or other similar information that are stored in a database or uploaded from client 14 with a cookie.

Web server 12 may store lower resolution color images as well as images that are less color-intensive, each of which may not be designated for color correction by the web administrator. Higher resolution color images and more color-intensive images can be stored at color image server 16. Client 14 may be one of many clients that download color images from web server 12, color image server 16, or both. There are potentially a large number of clients 14 downloading web pages from web server 12, along with tagged images from color image server 16.

Unfortunately, the display devices used by clients 14 may vary widely in calorimetric response. A color image that appears satisfactory when displayed on the display device of one client 14 may appear less than satisfactory when displayed on any of the display devices associated with other clients. Formulating the color commands set forth in the text files according to the colorimetric response characteristics of display devices associated with individual clients 14 can compensate for the differences. Setting the color values of tagged images can further promote color accuracy in a web page.

To obtain the necessary colorimetric response information, the invention may involve a color profiling process. With further reference to FIG. 1, color profile server 18 may administer the color profiling process for client 14. Once the color profiling process is complete, color profile server 18 generates information characterizing the calorimetric response of the display devices associated with client 14. The information for client 14 can be transmitted to color image server 16 by color profile server 18.

In one embodiment, the information for client 14 is stored in a color profile cookie that is downloaded to the respective client. In some embodiments, for style sheets, the information stored in the cookie may not necessarily contain data characterizing the colorimetric response of the display device, but may identify a unique style sheet associated with the client and stored in a database accessible by color image server 16. Alternatively, the cookie may store XML or other suitable code from which a style sheet can be dynamically generated. After receiving the color profile cookie, client 14 thereafter uploads the cookie to color image server 16 with requests for web page content.

To start the color profiling process, client 14 initially interacts with web server 12 to access a web page. On the first attempt to access a web page, client 14 may be redirected to color profile server 18 to complete the color profiling process for acquisition of calorimetric response information. In particular, the web page served by web server 12 may include a reference to a style sheet and one or more tagged images, stored on color image server 16, and be accompanied by one or more client-side scripts. Also, web server 12 may redirect client 14 to color image server 16 for color-corrected HTML or other code defining the web pages and the objects they contain.

When color image server 16 receives a request for a web page, style sheet, or tagged image, it first determines whether the requesting client 14 has a color profile. In one embodiment, color image server 16 detects whether client 14 has uploaded a color profile cookie. If so, it generally is not necessary to repeat the color profiling process for client 14. Rather, the colorimetric response information required by color image server 16 is stored in the cookie.

The cookie may contain, for example, parametric information characterizing the colorimetric response of a display device associated with client 14. Color image server 16 extracts the contents of the cookie and prepares a color profile for client 14. Alternatively, color profile server 18 may precompute a color profile based on the results of a color profiling process and then add the profile to the cookie. The parametric information or precomputed color profile may include information pertaining to the estimated blackpoint, gamma, and gray balance of a display device associated with client 14.

If color image server 16 does not detect a color profile cookie from client 14, the client is redirected to color profile server 18. Color profile server 18 then completes the color profiling process. The color profiling process may involve communication of one or more web pages from color profile server 18 to client 14. The web page can be designed to guide the user associated with client 14 through a series of steps for input of color response information such as blackpoint, gamma, and gray balance.

Color image server 16 extracts the colorimetric response information from the color profile cookie. Color image server 16 then retrieves the pertinent web page or other text file and, optionally, one or more tagged images requested by user 14. Using the color profile for client 14, color image server 16 formulates a customized text file such as a web page, script, or style sheet, as the case may be. Color image server 16 sets the color values specified in the HTML, script, or style sheet commands based on the color response of the display device associated with client 14. In this manner, the colors of the web page objects displayed by client 14 more accurately match the colors of the objects as originally intended.

In addition, color image server 16 may set the color values in a requested image. In particular, color image server 16 may apply color transformations, or other modifications, to the image to adjust the color values in the image based on the color response of the display device associated with client 14. Color image server 16 then communicates the color-modified image to client 14. In this manner, the color of the image displayed by client 14 more accurately matches the color of the image as originally intended.

Web server 12, client 14, color image server 16, and color profile server 18 each execute program code stored on computer-readable media residing either locally with the respective device or executed remotely. For client 14, for example, the program code may reside in random access memory (RAM) that is accessed and executed by the client computer. The program code can be loaded into the memory from another memory device, such as a fixed hard drive or removable media device associated with client 14.

The program code can be initially carried on computer-readable media, for example, such as magnetic, optical, magneto-optic or other disk or tape media, or electronic media such as EEPROM. Alternatively, the program code can be loaded into the medium by transmission from a remote data archive, e.g., via a local area network, wide area network, or global network such as the Internet. A substantial portion of the code may be web page code that is transmitted to the respective device and executed by a server or browser application.

Web page code, e.g., Hypertext Markup Language (HTML), Extensible Markup Language (XML), or the like, generated by web server 12 or color image server 16 may include image tags that point to specific color images stored at color image server 16 or elsewhere. When client 14 accesses a particular web page executes the HTML to assemble the page content, color image server 16 is accessed to obtain any images tagged within the web page code. Thus, the content of a web page assembled for client 14 may include images and other objects obtained from different resources within the network occupied by system 10, such as color image server 16.

In some embodiments, web server 12 and color image server 16 may be integrated with one another. In the example of FIG. 1, however, color image server 16 and web server 12 are separate entities. Web server 12 and color image server 16 each may interact with a common database server and file server to obtain access to selected color images and HTML files for delivery to client 14. Moreover, in operation, web server 12 may be realized by one of several web servers that access one or more common file and database servers. Likewise, color image server 16 and color profile server 18 may take the form of several servers that divide the computing load presented by clients 14 and other network interaction. In any event, the invention should not be limited to any particular platform, system, or architecture so long as it provides color correction functionality equivalent to that described herein.

Client 14 may take the form of a variety of devices that permit a user to access resources on system 10 and display color images obtained from such resources. Examples of client 14 include desktop or portable computers operating in a Windows, Macintosh, Unix, or Linux environment, personal digital assistants (PDA's), based on the Palm, Windows CE, or similar operating system environments for small portable devices, Internet-equipped wireless telephones, interactive televisions with set-top boxes for Internet access, Internet kiosks available to the general public, and future Internet appliances that may emerge.

Client 14 preferably executes a graphical viewing application such as a web browser to access resources residing on other resources, such as web server 12 and color image server 16, attached to system 10. A web browser application permits the user associated with client 14 to readily view web pages and images generated by web server 12, color image server 16, or color profile server 18. Other user interface applications may be useful in accessing web server 12 provided the information is presented in a user-interactive format.

In some embodiments, color image server 16 may be configured to deliver color corrected video imagery, in addition to static images and color-corrected web page code. Video, such as MPEG clips, streaming video, and the like may suffer from similar color accuracy issues if they are not compensated for the effects of the display device associated with an individual client 14. Thus, some embodiments of the invention may be useful for broadcast-like video content to the extent HTML, style sheets or text files capable of color specification are applicable.

In each case, clients 14 include a display device, such as a cathode ray tube or flat panel display, for display of color images obtained from web server 12 and color image server 16. Other types of displays as well as dynamic viewing media such as electronic paper are contemplated. Communication between web server 12, client 14, and color image server 16 may take place using conventional network protocols such as TCP/IP.

Although some of the client devices described above, such as PDA's and wireless telephones, presently incorporate relatively low quality color displays, it is anticipated that such devices will benefit from higher quality color displays in the near future. Accordingly, system 10 will be readily applicable in enhancing the quality of color images displayed by PDA's, wireless telephones, and similar devices in the future.

The color profiling process, and hence improved color accuracy, may be optional, for client 14. For some items, color accuracy may not be significant. When client 14 accesses a web page from web server 12, in some embodiments, the user may be given a choice between viewing a version of the web page with default color settings, which may be less accurate, or viewing a more accurate web page according to HTML, Java script, or style sheet code that has been formulated based on the results of the color profiling process. Thus, in some embodiments, color image server 16 or web server 12 may store a set of default web pages, style sheets, and the like to be used in the event the user does not elect the color profiling option.

A web page initially delivered to client 14 by color image server 16 may be embedded in a web page with one or more hypertext links for initiation of the color profiling process. The web page and the links may be served to client 14 in the event the color profiling process was not previously completed. Upon selecting an appropriate link, client 14 interacts with color profile server 18 to perform the color profiling process. If the link is not selected, client 14 simply views the default web page objects and image without the benefit of color modification by color image server 16. With the web page, client 14 also may view an indication of whether color profiling and correction has been applied. The indication may take the form of an icon that changes color to indicate when color profiling has been activated.

When the user clicks on the hypertext link to start the color profiling process, client 14 accesses color profile server 18 for delivery of a series of instructional web pages to the user. The web pages delivered by color profile server 18 guide the user through a number of steps designed to estimate the colorimetric response characteristics of the particular display device associated with client 14.

When the process is complete, color profile server 18 delivers a web page with content that, when executed, generates a cookie containing the color profile information. The cookie then can be uploaded to color image server 16 for use in modifying HTML, scripts, style sheets and color images for a web page to produce higher quality color output on the display device associated with client 14.

Other techniques for obtaining the color profiling information may not require direct interaction by the user with color image server 16. Instead, the user may voluntarily visit a web site to perform color profiling. The web site may be provided by color profile server 18 or be within the same domain as the color profile server. Alternatively, a user may profile the display device associated with its individual client 14 by executing software downloaded or physically delivered to them.

FIG. 2 is a block diagram of a web environment 20 incorporating a system as shown in FIG. 1. In the example of FIG. 2, web environment includes web server 12, which serves web pages via World Wide Web 22. Web environment 21 includes a number of clients 14₁-14_{N}. Color image server 16 serves images referenced by the web pages delivered by web server 12. Color profile server 18 guides the color profiling process by serving web pages to clients 14₁-14_{N} over World Wide Web 22. Color profile server 18 then transmits the colorimetric information obtained from clients 14₁-14_{N}, as color profiles or parametric information, to color image server 16 via World Wide Web 22. Color image server 16 then sends to clients 14₁-14_{N} web pages that, when executed, generate cookies containing the information. In this manner, the calorimetric information can be used in future downloads of web pages and color images.

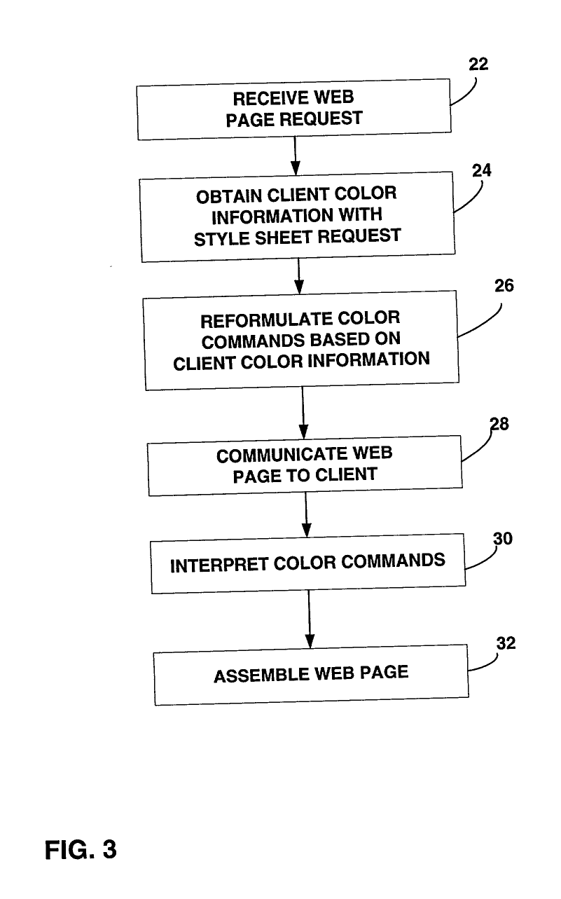

FIG. 3 is a flow diagram illustrating a process for serving color-customized web pages. As shown in FIG. 3, the method may include receiving a web page request (22) from a client 14. The web page request may be received by web server 12 or, in some embodiments, color image server 16. Also, web server 12 may provide client 14 with a redirect to color image server 16, which then communicates a color-corrected web page to the client. Upon requesting a web page from color image server 16, via a redirect from web server 12 in most cases, client 14 uploads a color profile cookie containing color information. In this manner, color image server 16 obtains color information for the client (24). The method further includes, based on the color information, reformulating a web page, script, or style sheet (26) based on the client color information. Color image server 16 then communicates the corrected text file to client 14 (28) for assembly of a web page. In preparing the web page, the web browser executed by client 14 interprets the color commands set forth in the text file (30). Then, the web page is assembled (32) by client 14 with more calorimetrically accurate web page objects.

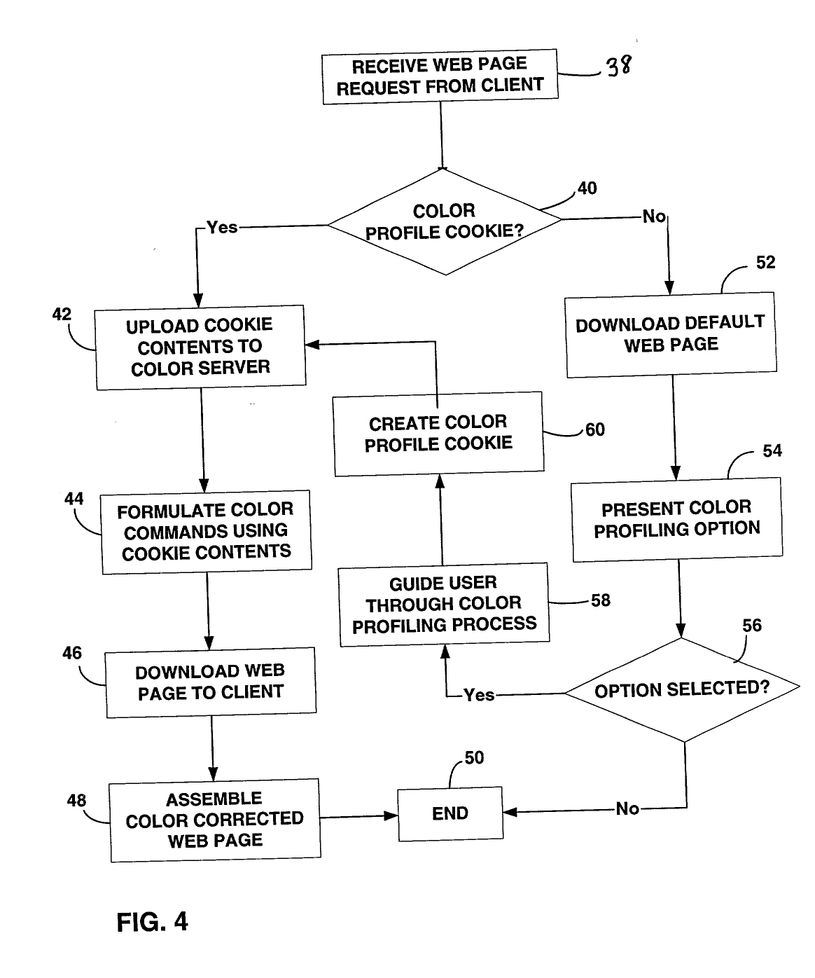

FIG. 4 is a flow diagram illustrating a process for serving color-customized web pages and profiling the color response of display devices associated with network clients. The process shown in FIG. 4 pertains primarily to formulation of color-customized web page objects. A similar process may be used, however, for color modification of tagged images. As shown in FIG. 4, when a client 14 requests the download of an image (38), web server 12 (or color image server 16 in the case of a redirect) determines whether the client has a color profile cookie (40). If so, the color profile cookie and its contents are uploaded to the respective server (42). If the color profiling process has been completed, client 14 will have a color profile cookie.

Based on the contents of the cookie, color image server 16 formulates color commands for client 14 (44), and downloads a web page containing the color-customized commands to the client (46). Using the color-customized commands, client 14 assembles a color corrected web page (48). In particular, the browser used by client 14 refers to the color commands for the color values assigned to the objects included in the web page. Color image server 16 sets the color values to compensate for the colorimetric response of the display device associated with client 14. Upon generation of the color corrected web page, the process ends (50), unless tagged images susceptible to color correction also are included in the web page.

If the color profile cookie does not exist (40), web server 12 or color image server 16 downloads a default web page (52) with color commands that have not been formulated specifically for the color response of client 14. Similarly, default style sheets and scripts may be used in this case. In the initial web page communicated to client 14, web server 12 provides a color profiling option (54). The option may take the form of an advisory that color profiling and more accurate web color is available, in conjunction with a hypertext link for selecting the option. If the color profiling option is not selected (56), the process ends (50) and client 14 simply views a web page assembled based on the default color commands.

If the color profiling option is selected, web server 12 or color image server 16 then provides a redirect to color profile server 18. Color profile server 18 guides the user associated with client 14 through a color profiling process (58). Based on the results of the color profiling process, color profile server 18 creates a color profile cookie (60) and downloads it to client 14 for use by color image server 16 in formulating color-customizable color commands. Although FIG. 4 shows an immediate transition from step (60) to step (42), the contents of the cookie may not be uploaded to color image server 16 until another image is requested by client 14.

Interaction between web server 12, client 14, color image server 16, and color profile server 18 is driven by web pages delivered to the client. This approach yields significant convenience for the end user associated with client 14. At the same time, color image server 16 is not required to retain color information for individual users, and recall that information each time a new web page is downloaded. Rather, the information can be uploaded to color image server 16, e.g., in the form of a cookie, whenever web pages or tagged images are requested by a client 14.

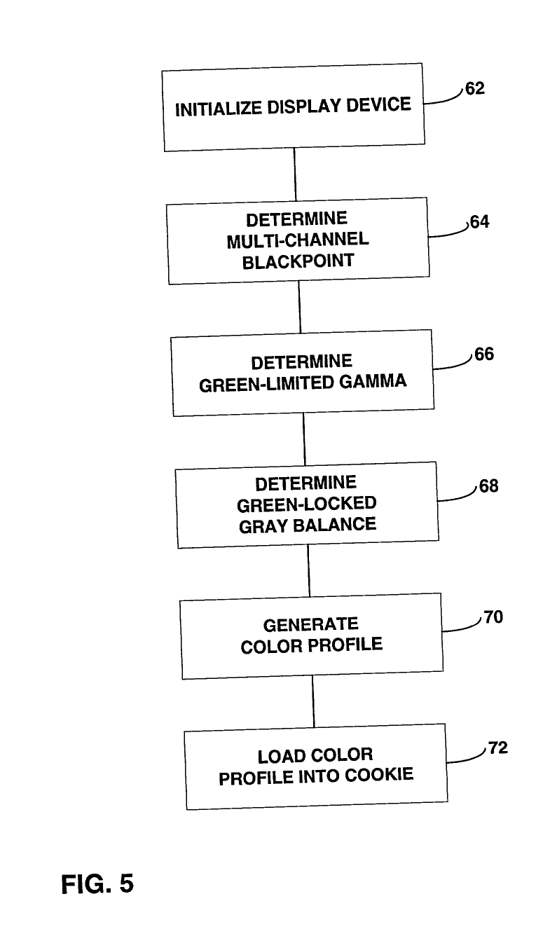

FIG. 5 is a flow diagram illustrating a color profiling process in greater detail. As shown in FIG. 5, the color profiling process for client 14 may involve initialization of the display device to a standard setting (62). The process then determines a blackpoint estimate for the display device (64). The blackpoint estimate may be a multi-channel blackpoint estimate. Upon determination of the blackpoint estimate, the process obtains an estimate of the gamma for the display device (66). The gamma may be limited to the green channel.

Next, the process determines a gray balance for the display device (68). The gray balance estimate can be locked to the green channel in the sense that the green-limited gamma from the gamma estimate may be held constant while red-blue shifts are explored to determine gray balance. In other words, the gray patch used as the central patch in the gray balance determination is a combination of red, green, and blue based on the green-limited gamma estimate. When the blackpoint, gamma, and gray balance have been estimated, a color profile is generated (70). The color profile contains information representing the blackpoint, gamma, and gray balance of the display device. The color profile, or parameters useful in forming the color profile, can be loaded into a web cookie (72). The web cookie is stored by the client 14 for uploading to color image server 16 when a subsequent web page or tagged image is requested.

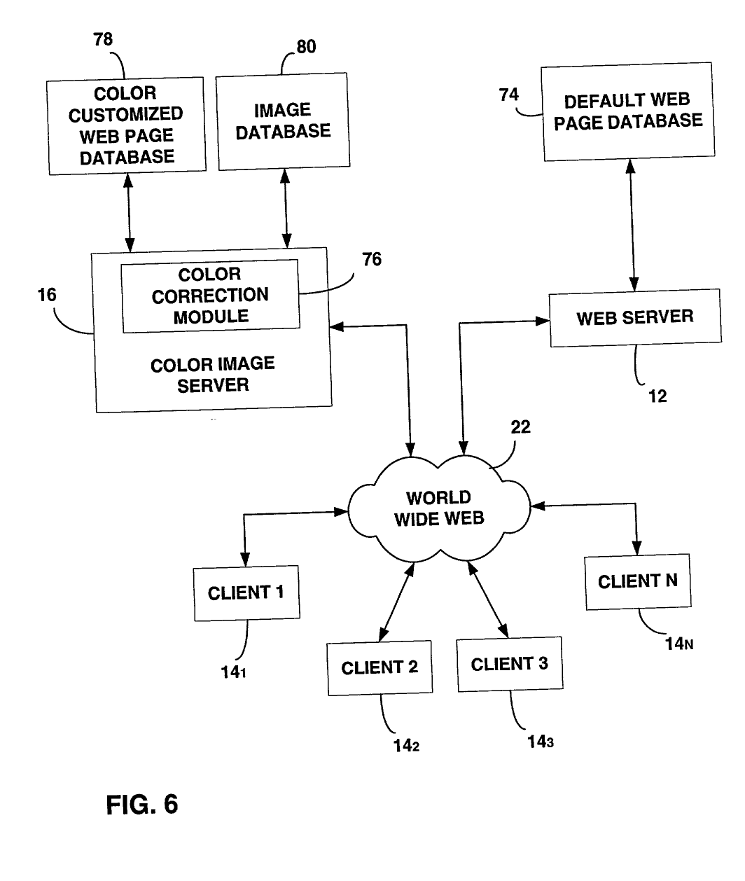

To carry out a color profiling process as described with reference to FIG. 6, client interacts with color profile server 18. Color profile server 18 delivers a series of web pages to client 14. Each of the web pages is designedto guide the user through a given step in the color profiling process. One web page, for example, may include instructions and image content designed to extract from the user an estimate of the blackpoint of the display device.

In one embodiment, the blackpoint estimate may be an estimate of multiple, channel-specific blackpoints. Other web pages may include instructions and content designed to extract coarse gamma, fine gamma, and gray balance information. In particular, each web page may include interactive media such as hypertext icons and the like that can be clicked upon by the user to transfer information from client 14 to color profile server 18. Upon collecting the necessary information, color profile server 18 creates the cookie and delivers it to client 14 for local storage and future use.

FIG. 6 is a block diagram illustrating a system for serving color-customized web pages in greater detail. As shown in FIG. 6, web server 12 accesses a default web page database 74 to communicate web pages to clients 14₁-14_{N} via web 22. In one embodiment, color image server 16 accesses a color-customizable web page database 78 and an image database 80. Image database 80 contains tagged images referenced by the web pages served by web server 12. Color-customized web page database 78 contains web pages served by web server 12.

In the embodiment of FIG. 6, color image server 16 also includes a color correction module 76. Color correction module 76 may be a process running on color image server 16 that responds to requests for color-customized web pages or images from clients 14₁-14_{N}. When a client 14 requests a color-customizable web page from web server 12, the web page provides a redirect to color image server 16 and references a corresponding web page stored in color-customizable web page database 78.

Color image server 16 retrieves the web page and, if client 14 has uploaded a color profile cookie, formulates a web page with customized color commands. In particular, color correction module 76 modifies the default color commands based on the color response characteristics indicated by the color profile cookies. Color correction module 76 sets the color values in the color commands to compensate for calorimetric response differences in the display device associated with client 14. Using the customized web page commands, a browser on client 14 assembles a web page with color-corrected objects.

If the web page contains tagged images, color image server 16 also engages color correction module 76 to produce color-corrected images. Again, using the contents of the web cookie, color correction module 76 sets the color values in the images based on the color response characteristics of the display device associated with client 14. Color image server 16 then downloads the color-corrected image to client 14, providing a color-customized web page with both color-corrected images and color-corrected web page objects. Color image server 16 may provide similar customization for style sheets and script files associated with the requested web page.

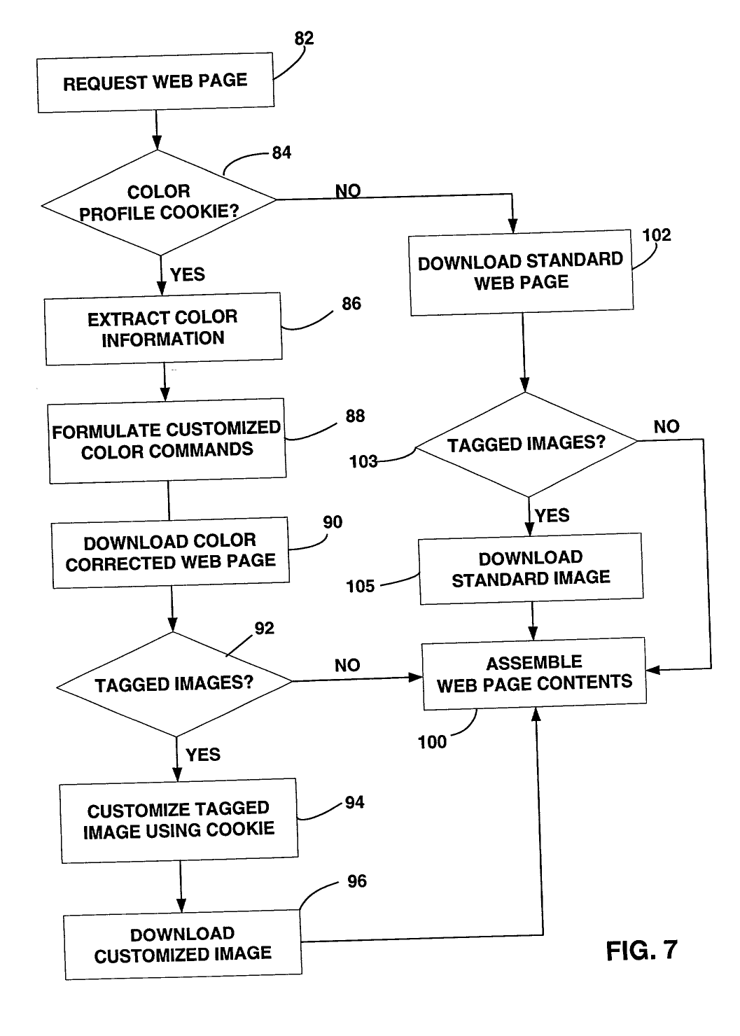

FIG. 7 is a flow diagram illustrating a process for serving web pages with color-customization of web page objects and tagged images. When a client 14 requests a web page (82), color image server 16 determines whether the client has a color profile cookie (84). If client uploads a color profile cookie, color image server extracts the pertinent color information (86). Using the color information, color image server 16 formulates a web page with customized color commands (88), and downloads it to client 12 (90).

If the web page includes a tagged image (92), color image server 16 customizes the color values in the tagged image using the cookie contents (94). Color image server 16 then downloads a customized image (96) to client 14. Using the customized style sheet and customized color image, the web browser at client 14 assembles the contents of the web page (100). If the web page does not include a tagged image, the web browser at client 14 assembles the web page content without images.

If a color profile cookie is not available (84), color image server 16 accesses the standard or “default” web page (102) and downloads it to client 14 without customized of the color commands in the web page. If the web page includes tagged images (103), color image server 16 downloads a standard, non-customized image (105) to client 14. Using the standard image and the standard color commands in the web page, the browser at client 14 assembles the contents of the web page (100).

The particular manner in which color image server 16 sets the color values in a web page, style sheet, java script, or tagged image is straightforward. The color of a web page object can be represented as a hexadecimal value of RGB (red, green, blue). The format of the hexadecimal number typically is rrggbb, where “rr,” “gg,” and “bb” designate values of red, green, and blue, respectively, ranging from 0 to 255. Thus, a hexadecimal value of ffffff specifies a combination of red, green, and blue at maximum intensity. Specifically, red, green, and blue are each set at ff=255, typically producing a maximum white color on the screen. If the hexadecimal color value were 000000, the color on the screen would be black. Once the appropriate color value is determined, color image server 16 sets the hexadecimal color value for a pertinent web page object using the above approach. In particular, color image server 16 parses the pertinent text file to identify the color commands and substitutes values determined on the basis of the colorimetric characteristics for the pertinent display device. Of course, the invention can be readily adapted to process color values that are expressed in a format other than hexadecimal.

As an alternative or additional approach, color image server 16 may enter changes to the default color values used in the text file. A style sheet, for example, may contain sixteen default colors: aqua, black, blue, fuchsia, gray, green, lime, maroon, navy, olive, purple, red, silver, teal, white, and yellow. These sixteen colors are taken from the Windows VGA palette. Each color carries a default color value. Some browsers support a wide variety of additional color names, such as the X11 colors. When a particular color is called out in the style sheet, the corresponding default color value is applied to the pertinent web page object. By adjusting the default color values, the colors applied when the default color is invoked can be modified. This approach only provides sixteen points of adjustment, however, making the specification of specific color values using hexadecimal values more desirable in most color-intensive applications. If a larger palette is used, e.g., 256 colors, this may be a useful and desirable approach. It is possible to simply convert a default color to hexadecimal code, modify the resulting code, and serve it in the place of the default color.

The color profiling and cookie management processes will now be described in greater detail. The processes will be described in the context of a web environment having multiple web servers 12, multiple color image servers 16, and one or more color profile servers 18. Exemplary color profiling and cookie management processes are disclosed in U.S. provisional application serial No. 60/193,725, filed Mar. 31, 2000, U.S. application Ser. No. 09/631,312, filed Aug. 3, 2000, and U.S. provisional application serial No. 60/246,890, filed Nov. 1, 2000. The content of each of the foregoing patent applications is incorporated herein by reference in its entirety. The color profiling and cookie management processes described herein for use in conjunction with the invention are purely exemplary and not to be considered limiting of the invention.

The administrator of a website may control one of web servers 12 and color image servers 16. In other words, the administrator may be responsible for maintenance, administration, and content of a particular web server 12 and color image server 16. In this manner, the administrators can readily update the contents of web servers 12 and color image server 16. Consequently, the administrators do not need to relinquish control of their image content to some third party in order to take advantage of color image quality improvements. Instead, the administrators make use of their own color image server 16, which interacts with a color profile server 18 that guides the color profiling process for each client 14. Thus, color profile server 18 may be a central server or collection of servers used to provide color profiling for multiple web site domains, whereas web server 12 and color image server 16 preferably is controlled by an individual website administrator or entity. Nevertheless, in some embodiments, use of a central image server for all websites may be acceptable.

Color image server 16 can be a server that is collocated with or remotely located from a corresponding web server 12 and contains the high resolution or color-intensive color images for the pertinent website and a color correction module for modifying the images and serving color-corrected images for clients 14. Each color image server 16 may be within the domain of the respective web server 12, but this is not a requirement.

Notably, as will be described, the color profiling process optionally requires no plug-ins, Java scripts, or other significant client-side processes. Instead, interaction between web server 12, client 14, color image server 16, and color profile server 18 is via execution of the web page code delivered to the clients. This approach yields significant convenience for the end user associated with client 14. At the same time, web server 12 and color image server 16 are not required to retain color information for individual users.

Rather, the information can be uploaded to color image server 16, e.g., in the form of a cookie, whenever color images are requested by a client 14. Moreover, site administrators can maintain their own color images at color image server 16, and provide color correction by incorporating a color correction module capable of handling the color profile cookies uploaded by individual client 14. Accordingly, there is no need for the site administrators to post their web pages or images to a central web repository.

To carry out a color profiling process, client 14 interacts with color profile server 18. Color profile server 18 delivers a series of web pages to a client 14. Each of the web pages is designed to guide the user through a given step in the color profiling process. One web page, for example, may include instructions and image content designed to extract from the user an estimate of the blackpoint of the display device.

In one embodiment, the blackpoint estimate may be an estimate of multiple, channel-specific blackpoints for the individual color channels of the display device. Other web pages may include instructions and content designed to extract coarse gamma, fine gamma, and gray balance information. In particular, each web page may include interactive media such as hypertext icons and the like that can be clicked upon by the user to transfer information from client 14 to color profile server 18.

Upon collecting the necessary information, color profile server 18 creates the cookie and delivers it to the client 14 for local storage and future use. In some embodiments, two cookies can be provided to client 14. A first cookie may correspond to a domain name associated with color profile server 18, and be used for future interaction between the particular client 14 and the color profile server. The first cookie can be referred to as the “profiler cookie.”

A second cookie may correspond to a domain name associated with the particular color image server 16, e.g., corresponding to a particular auction or photo site, from which the color image is to be downloaded. In other words, the second cookie may correspond to the particular color image server 16 at which the color profiling process was initiated. In this manner, future images delivered by that color image server 16 will be modified based on the contents of the cookies associated with the pertinent domain. The cookies will be provided by the client 14 that requested a download of the image. The second cookie can be referred to as the “image server cookie.”

The profiler cookie can be used to produce additional image server cookies for use with color image server 16 associated with other domains. Specifically, when a user situated at a client 14 accesses a color image server 16 from which the user has not previously downloaded color corrected images, the user can click on the color profiling option and be directed to color profile server 18. Upon interaction with color profile server 18, client 14 simply uploads the profiler cookie instead of repeating the color profiling process. Information concerning the domain associated with the new color image server 16 can be incorporated in the profiler cookie.

In response to receipt of the profiler cookie, color profile server 18 delivers a web page advising the user associated with client 14 of the intent to send the cookie contents to the domain indicated in the cookie, and may request user approval for, among other reasons, privacy concerns. Upon approval by the users, color profile server 18 transmits the cookie contents to the color image server 16 designated by the domain in the profiler cookie.

Color image server 16 creates an image server cookie for its own domain, and writes the cookie to client 14 for future use. Thereafter, client 14 uploads the appropriate image server cookie to the color image server 16 when requesting color corrected images for the pertinent web server 12, and can bypass interaction with color profile server 18. Client 14 uploads the appropriate image server cookie to color image server 16 when attempting to upload images.

The reliance on first and second cookies, one for color profile server 18 and the other for a particular web server 12 or color image server 16, is driven in part by existing web design considerations. In particular, cookies stored on a browser for a client typically are marked by the domain of the server that generates them, and are not generally visible to other domains. Thus, cookies created by color profile server 18 are not generally visible to color image server 16, and vice versa.

Further, cookie visibility can be further restricted by marking the cookie with a path within a server's domain. This sort of cookie will then not be visible on requests to pages outside the path, even if to the same domain. Further, a browser routinely sends all visible cookies on each request to a server. This includes not only the initial request for an HTML page, but also the requests for images to be embedded in the page. Because an image can come from a different server than the HTML page, however, the cookies sent for the HTML page can differ from those sent for the image.

In light of the above considerations, color profile server 18 acts as an intermediary not only for administration of the color profiling process, but for generation of image server cookies. This intermediary function enables color correction of all subscriber images to be performed at color image server 16 rather than at a centralized site. Also, with this intermediary function, once a client has gone through the color profiling process, he generally will not have to repeat it to obtain color correction of images for additional subscribers.

As an exception, the user may voluntarily repeat the color profiling process when local driver software or hardware such as the display device or video card associated with a client 14 has changed. Indeed, to encourage updates from time to time in order to accommodate hardware changes, expiration dates can be applied to the profiler cookie and image server cookies.

It is apparent that the three different servers, i.e., web server 12, color image server 16, and color profile server 18, divide the labor involved in color correction transactions. In particular, assuming the existence of a profiler cookie and an image server cookie, a web server 12 serves the HTML for the subscriber's own web pages and handles most other requests for those pages, including serving of images that are not subject to color correction. Color image server 16 serves the images that are subject to color correction.

If color image server 16 receives a color profile cookie from a client 14, it performs color correction based on the cookie contents and the contents of the pertinent color profile cookie, and serves the color corrected image to the client. Color image server 16 also may serve an icon near the correctable color images that indicates whether the color images have indeed been corrected. If color image server 16 finds no color profile cookie, for example, it displays an icon suggesting that the user click the icon to initiate the color profiling process. Otherwise, the icon merely indicates that color correction is turned “on,” i.e., that color correction has been applied to the image.

Color profile server 18, as mentioned above, serves the pages for the color profiling process. If the color profiling process is invoked by clicking the icon displayed with a color image delivered by color image server 16, the respective client 14 probably does not have an image server cookie for the pertinent web server 12. In some cases, however, client 14 may be voluntarily repeating the color correction process to update the profile for new hardware or software. If a profiler cookie exists, then the process can be abbreviated by simply shipping the contents of the cookie to the appropriate image server domain for creation of the image server cookie.

If the profiler cookie does not exist, then the full color profiling process is served by color profile server 18. Upon completion of the color profiling process, color profile server 18 generates the profiler cookie for client 14, and passes the contents of the profiler cookie to the pertinent color image server 16. Color image server 16 then generates the image server cookie based on the profiler cookie contents and invokes the original web server URL from which the color profiling process was invoked.

The mechanisms for exchanging color correction information between the profiler cookie generated by color profile server 18 and the image server cookie generated by color image server 16 may vary. In particular, rather than delivering cookies to client 14, color profile server 18 may be arranged to transmit the color correction information to all of the color image server 16 associated with a recognized group of web servers 12.

In this manner, the color profile information obtained by color profile server 18 as a result of the color profiling process can be “broadcast” for storage by web servers 12 or color image server 16. The advantage of this approach is that information transfer is seamless. There is no need for the user associated with a client 14 to interact with color profile server 18 following the initial color profiling process, other than to update the color profile. Rather, each web server 12 or color image server 16 stores the color correction information associated with the individual client 14, e.g., with a client ID code.

When a client 14 accesses one of the color image servers 16, the client ID code is used to retrieve the appropriate color correction information and thereby serve a color corrected image. The downside is that each web server 12 or color image server 16 may need to maintain a database of color correction information for clients 14, including clients who may never access a respective web server 12. Thus, an approach that makes use of cookies for transfer of color correction information may be more efficient and more desirable for some site administrators. Nevertheless, broadcasting of color correction information remains a viable option that may be acceptable to some site administrators, and highly convenient for end users.

The following is a description of some of the details that may be involved in passing information between web servers 12, clients 14, color image server 16, and color profile server 18 according to an indirect cookie transfer approach. This approach is indirect in the sense that the user intervenes and enters approval before the profiler cookie contents are transferred from color profile server 18 to a respective color image server 16. In delivering web pages to clients 14, web server 12 passes the URL's for correctable images stored on associated color image server 16. In addition, web servers 12 preferably incorporate color profiling icons near the images. URL's for the color profiling icons point to the pertinent color image server 16, while the hypertext link associated with the icon points to color profile server 18.

To accomplish passing of color correction information back to color image server 16, the URL of the page viewed by the user is passed to color profile server 18 when the hypertext link associated with the icon is followed by a client 14. This step of passing the URL can be accomplished either by including the URL as a parameter on the target URL, or by POSTing the information from a form that wraps the icon, i.e., with the URL stored in a hidden entry field. In the latter case, the icon serves as a button, which may require some minimal client-side scripting. In addition, as will be described, the name of web server 12 and the URL of a completion page to be served by color image server 16 after the color profiling process is complete may be included in the request to color profile server 18. Web servers can be provided with a server-side scripting function that inserts the icon code with the appropriate URLs.

For the color profiling process, color profile server 18 serves a number of web pages that can be invoked by execution of a web page provided by web server 12. In this case, the “return URL” is passed forward to each page in the sequence. The return URL can be passed as a parameter in the target URL, or by using hidden fields in forms. In some cases, the return URL can be stored as a server variable. As mentioned above, color profile server 18 handles two scenarios: (1) full color profiling when no profiler cookie exists, and (2) creation of an image server cookie when a profiler cookie already exists. In both scenarios, color profile server 18 transfers the contents of the existing or newly created profiling cookie to the pertinent color image server 16. In particular, color profile server 18 may present a button that requests permission of the user associated with a client 14 to transfer the information.

The URL for the button points to a page served by color image server 16. The request sent to color image server 16 includes both the return URL and the color information written in the profiler cookie. The request preferably is a POST request from a form, rather than a GET request with all the information set forth in the URL due to length considerations. Color profile server 18 determines the URL of the destination page at color image server 16 by reference to the return URL. Prior to transfer of the cookie contents, the user will want to know the destination.

Accordingly, color profile server 18 displays the name of the particular color image server along with the button. The name of the color image server may be associated with the web site served by web server 12. If the name of the web site is not easy to determine from the URL, it can be generated by cross-referencing the URL to a name in a database accessible by color profile server 18, or by passing the name with the return URL in the original request from the page generated by web server 12.

Upon receipt of the information from color profile server 18, the pertinent color image server 16 serves a page indicating that the color profiling process is complete. The page may be invoked by the POST request containing the color correction information and the URL of the “return” page, as received from color profile server 18. Color image server 16 writes the color correction information to the pertinent client 14 as a client cookie.

From that point forward, the image server cookie is stored by the respective client 14, and is sent to the color image server 16 associated with the pertinent web site with any request for upload or download of a color correctable image. In response to a download request, color image server 16 extracts the contents of the image server cookie from the client 14, applies a color correction to the requested image based on the contents, and delivers the color-corrected image to the client 14. In response to an upload request, color image server 16 accepts the image, extracts the contents of the image server cookie from client 14, and associates the cookie contents with the image for future use.

As an alternative approach, color correction information can be passed from color profile server 18 to a color image server 16 via a direct request, rather than being embedded in a request generated when a client 14 clicks on a button, anchor, or other input medium. This approach is direct in the sense that the user need not intervene by submitting approval for the transfer to color profile server 18. Instead, the transfer of the content of the profile cookie to the appropriate color image server 16 can be made seamless and occur in the background.

Indeed, in preferred embodiments, the user associated with client 14 may not even view pages sent by color profile server 18 for transfer of information following the initial profiling. In this manner, the transfer of color correction information from color profile server 18 to a color image server 16 happens automatically, without requiring the user associated with a client 14 to click on a link to effect the transfer. This approach makes the transfer appear more seamless to the user. The end result is the same, i.e., the transfer of color correction information contained in a profiler cookie to create an image server cookie without the need for reexecution of the color profiling process by the user.

To facilitate transfer by direct request, a client 14 can be assigned a client ID. Ordinarily, the client ID can be stored in and received from an image server cookie on the browser associated with a client 14. A client 14 that is new to the particular web site, i.e., a client that does not send an image server cookie to the particular color image server 16, will be assigned a new client ID, which is sent as a cookie with the HTML in the response from the color image server.

All URLs pointing to color profile server 18 then bear both the client ID and a web site ID as parameters, so that the color profile server can correlate requests for color correction information for the respective client 14. The URL for the color profiling icon points to color profile server 18 if there is no image server cookie. For this approach, it is preferred that the respective web server 12 and corresponding color image server 16 occupy the same domain so that they can view the same cookies.

As in the indirect approach, a color profiling icon, which appears adjacent a color correctable image or with a dialog for upload of an image, may be served from either color image server 16 or color profile server 18 in the direct transfer approach, depending on whether the color image server receives an image server cookie. If an image server cookie is present, the profiling icon is served by color image server 16 with a downloaded image, and is formulated in appearance to indicate that color correction is active, e.g., with a text message to that effect. This will be the case for most images served by color image server 16 because only new clients 16 will not have the image server cookie.

If the image server cookie is not presented, the icon is served by color profile server 18. In other words, the web page served by color image server 16 has embedded in it an icon served by color profile server 18. If a profiler cookie is present, color profile server 18 serves an icon that indicates the client 14 has already been through the color profiling process. If not, the icon indicates that the color profiling process has not previously been completed by the respective client 14. This may be represented by a colored icon to indicate that color profiling has been completed, and a black-and-white icon to indicate that it has not.

In some embodiments, the icon may indicate that the client 14 has been through the color profiling process, but that the color correction information has not yet been forwarded to the particular web site, and that the image has not been color corrected. In either case, color profile server 18 also receives the ID for the client 14 and the particular web site, which are included in the URL forwarded to color profile server 18. If the profiler cookie is present, color profile server 18 immediately forwards the client ID and the contents of the profiler cookie to the pertinent color image server 16 in a special-purpose request.

If the image server cookie is presented by a client 14, color image server 16 performs the color correction based on the information contained in the cookie. For a client 14, color image server 16 accepts the contents of the image server cookie and associates it with the uploaded image for later retrieval during color modification. If the image server cookie is not present, color image server 16 waits a short time to receive color information for this client 14 from color profile server 18. If the information is forthcoming, color image server 16 writes an image server cookie to the browser associated with the client 14. Otherwise, color image server 16 serves an uncorrected image to client 14 or, in the case of client 14, does not establish information for color correction of the uploaded image.

With this direct approach, it may be necessary for color image server 16 to keep track of color correction information forwarded by the color profile server 18 because such information may not be received synchronously with image upload and download requests from client 14, respectively. Accordingly, it may be necessary to incorporate a database application that can be shared by color image server 16 for temporary tracking of color correction information associated with individual client 14, and web server 12 for tracking and generation of client ID information. Once the information has been written to an image server cookie, the ID and color correction information for the respective client 14 can be purged from the database.

Management of ID's according to the direct transfer approach may take place as follows. The original color correction information generated by color profile server 18 can be stamped with a unique ID. The unique ID can be maintained in copies of the color correction information forwarded to color image server 16. This ID changes if the client 14 repeats the color profiling process, and can be referred to as the profiler ID. The profiler ID will remain unchanged until the next pass through the color profiling process, which may occur months later. In effect, the profiler ID corresponds to a particular color profiling sequence. The profiler ID is supplemented by the client ID and the subscriber ID. The client ID identifies a client for whom a web site is requesting color information, and the subscriber ID identifies the particular subscriber.

The client and subscriber IDs are passed via URL parameters to color profile server 18 whenever a color image server 16 has no color correction information for a particular client 14. The subscriber ID is passed back with the color correction information from color profile server 18 to color image server 16 when the color profile server determines the appropriate information for the client, based on the contents of a profiler cookie or the results of running the color profiling process. Once color image server 16 receives this information and writes it as an image server cookie to the client's browser, the subscriber ID is no longer needed.

FIG. 8 is a flow diagram illustrating a color profiling process for a display device. A process as shown in FIG. 8 can be used to generate the contents of a profiler cookie as discussed above. Notably, the entire color profiling process can be completed by the user associated with a client 14 with as few as three “clicks” of a pointing device. If the user is required to click a continue button to proceed after selecting a patch, the process may take additional clicks. If the user is permitted to proceed automatically following selection of a patch, however, the entire process can be completed in three clicks. With optional analog adjustment, separate R,G, and B blackpoints, and fine gamma steps, to be described, the process may require up to six or seven clicks. In many embodiments, the color profiling process requires no plug-ins or client side scripting when utilizing the method of selecting discrete elements, although such mechanisms can be provided in some embodiments such as in the use of slider adjustments.

The color profiling process enables visual profiling of a display device associated with a client 14 by determining accurate values of blackpoint and gamma for the R,G, and B phosphors or photodiode elements. Gamma refers to a parameter y that indicates the rate of change in light intensity with change in digital device value. The term “blackpoint” is well known in the art and refers to the R, G, or B values lower than which there is no decrease in light emitted by the display device. Blackpoint is sometimes alternatively referred to as black onset. In accordance with the invention, three separate blackpoints are optionally determined, one for each of the R, G, and B color channels of the monitor. For use with more accurate monitors, a single dark gray RGB selection can be used to estimate a single average blackpoint value for R, G, and B.

In some display devices, such as older CRT monitors, different color channels can produce very different blackpoints. Accordingly, reliance on a single RBG blackpoint measurement in generating a color profile can introduce inaccuracies. Determination of channel-specific blackpoints, however, can reduce the degree of inaccuracy. In other words, by estimating the blackpoint for each color channel individually, a more accurate characterization of the calorimetric response of the display device can be obtained. A more accurate calorimetric characterization enables greater accuracy in conversion of color images for delivery and display on the particular monitor. For purposes of example, alternative color profiling processes are disclosed in U.S. patent application Ser. No. 09/631,312, to Kruse et al., filed Aug. 3, 2000, and entitled “COLOR IMAGE DISPLAY ACCURACY ACROSS A GLOBAL COMPUTER NETWORK,” the entire content of which is incorporated herein by reference.

Color profile server 18 may administer a color profiling process as shown in FIG. 5 by serving a series of instructional web pages to client 14. In general, the color profiling process may involve determination of (1) blackpoint for each of the red, green, and blue (R, G, and B) color channels of the display device, (2) average gamma for R, G, and B, and (3) differences in gamma for R, G, and B. Due to the wide range of differences in display device properties, determination (2) above can be subdivided into determination of (2a) a coarse gamma estimate, and (2b) a fine gamma estimate. This process is described in greater detail below with reference to FIGS. 8-14.

The color profiling process first involves determination of an estimated blackpoint for each of the color channels of the color display device, e.g., R, G, B. After determining the blackpoints, which may be merely an estimate, the color profiling process involves determination of the gamma exhibited by the display device. In particular, the process may involve determination of a coarse gamma, followed by determination of a fine gamma. Determination of the fine gamma may rely in part on the coarse gamma. In other words, the coarse gamma can be used as an initial estimate and starting point for convergence toward a more finely tuned gamma.

After determining the fine gamma, the process may involve determination of the gray balance exhibited by the display device. Gray balance provides an indication of the amount of color shift of a neutral gray toward one or more of the color channels used by the display device, e.g., red, green, and blue. The gray balance determination may rely in part on the gamma determined previously in the color profiling process and, in a particular embodiment, the fine gamma. Next, the color profiling process involves generation of a color profile. The color profile contains information that characterizes the color response of the display device based on the blackpoints, gamma, and gray balance. The color profile then can be loaded into a cookie, or other content container, and stored locally with each client 14 for uploading to any of color image server 16 when needed.

The estimated blackpoint parameters define the dynamic range of the display device. Because the maximum RGB value always defines white, the blackpoint defines the black end point, and therefore defines the domain of values for each of the R, G, and B color channels that results in a continuous change from black to white. Again, blackpoint refers to the R, G, or B value below which there is no further decrease in light emitted by the display device. For an individual color channel, such as R, the blackpoint is the point at which further decreases in the R value produce no further decreases in R channel light emitted by the display device. If the blackpoint for a given color channel of a display device is high, values for that channel in darker regions will be mapped to the darkest shade and shadow detail will be lost if no image correction is performed. Accordingly, obtaining an accurate blackpoint estimate is important for the accuracy of images represented by the display device.

In addition to a multi-channel blackpoint estimate, the color profile may include a gamma parameter and a gray balance parameter. The parameters together define the colorimetric response of an individual display device to enable modification of color imagery for more accurate representation on the device. The gamma parameter most affects the overall appearance of the image. Gamma determines whether an image appears overall too light or dark, or with too much contrast or too little. The third parameter, R, G, B gamma difference or “gray balance,” is important because the human eye is very sensitive to gray balance. The gray balance parameter indicates the relative balance, or imbalance, between the different color channels of a display device when producing RGB color combinations.

For blackpoint determination, as shown in FIG. 8, color profile server 18 first may serve a web page for display device adjustment. The web page instructs the user to adjust the brightness and contrast of the display device. This step of display device adjustment is optional, but generally desirable in preparing the display device for blackpoint determination. Color profile server 18 may serve a web page containing several rows of dark elements such as bars, patches, characters, letters, numerals, and the like (104).

Instead of patches or bars, it may be desirable to display elements with alternative shapes such as numerals. Whereas the patches or bars may be generally rectangular, more complex shapes can be used to aid the human eye in resolving differences. Thus, numerals, letters, and other complex shapes, for example, engage the pattern recognition capabilities of the human eye and can result in heightened sensitivity to gray scale differences. When the human eye is called upon to perform pattern recognition, its sensitivity to color gradations between a given pattern and a surrounding area increase. The complex shape presents a longer boundary relative to simple shapes, and promotes an increased perimeter for contrast. Elements with complex shapes may be used in the blackpoint, coarse gamma, and fine gamma determinations to characterize the monitor.

As an alternative to rows, the elements can be arranged in columns placed side- by-side across the web page. As a further alternative, each row or column may contain, instead of several elements, only one or a small number of elements. A larger number of elements in each given row may aid the user in resolving differences between elements in adjacent rows.

The web page may instruct the user to set the brightness and contrast of the display device to maximum (106). The rows (or columns) of elements may be arranged in a series. The elements in each row preferably exhibit the same darkness or lightness. However, the elements in each row in the series differ in relative darkness or lightness relative to the elements in other adjacent rows. For example, the darkest row of elements could be situated at the bottom, with rows containing elements with progressively lighter shades being situated above in ascending order. The web page instructs the user to reduce the brightness until the darkest row of elements is barely visible (108). At this point, the user may select “next” or some similar hypertext icon and proceed to the next step in the color profiling process, e.g., blackpoint determination for each of the red, blue, and green channels on an individual basis.

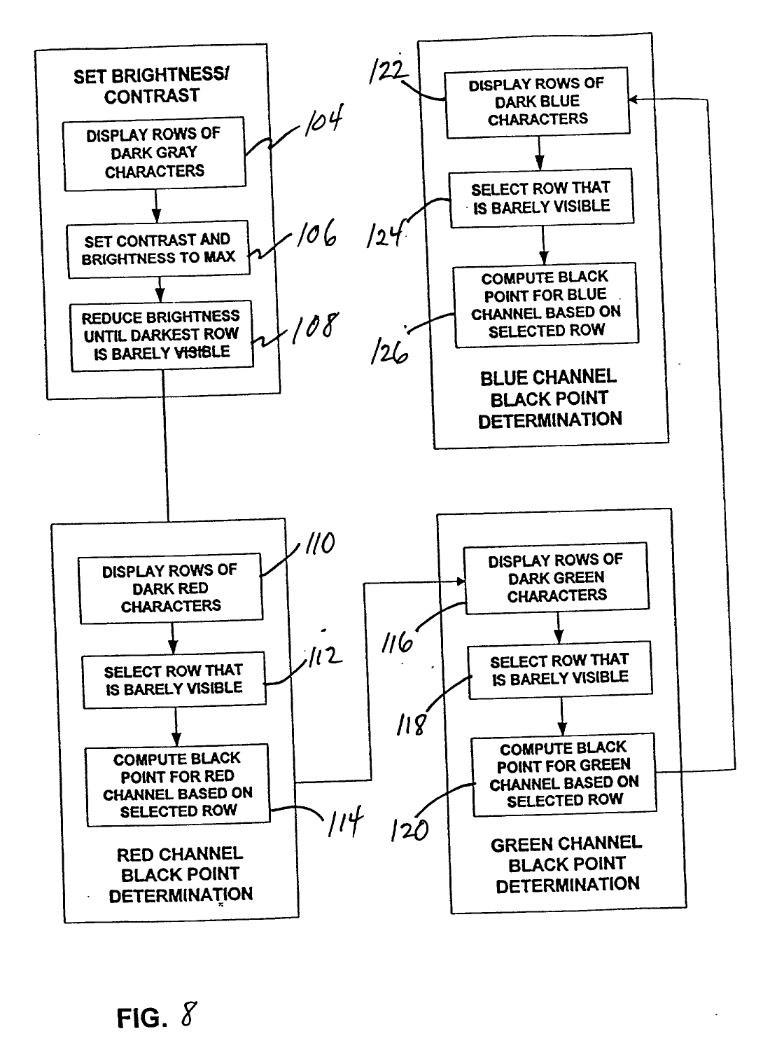

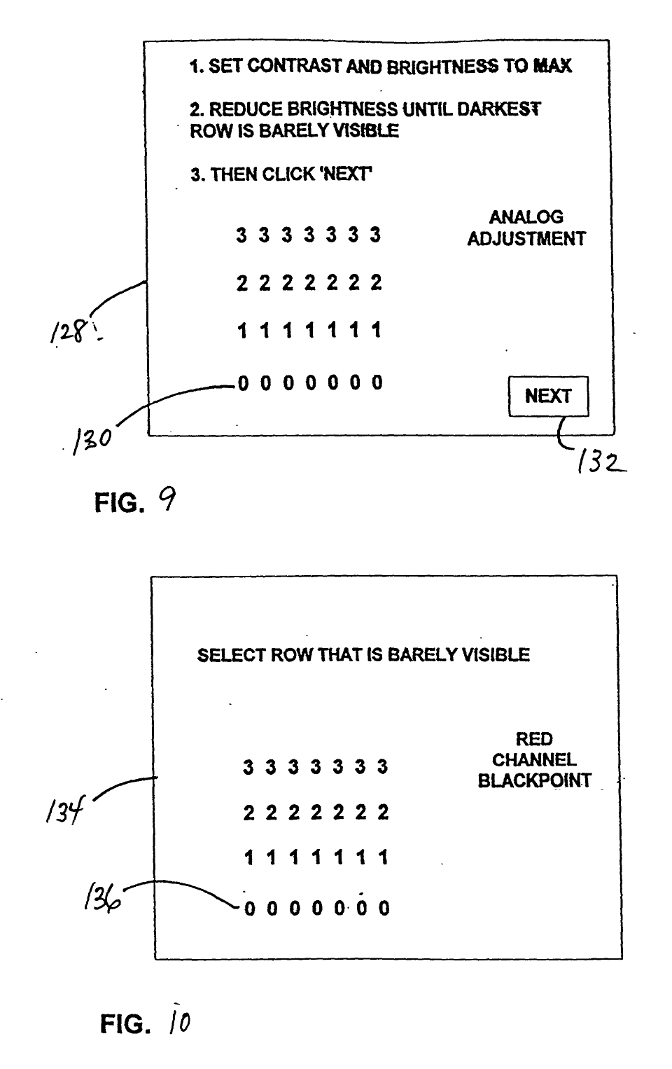

FIG. 9 illustrates a web page 128 for use in display device adjustment in a color profiling process as shown in FIG. 8. Rows 130 of dark elements are displayed, with the elements each row having the same gray level value, but different gray level values from elements in adjacent rows. As an example, rows 130 of dark elements (shown as numerals in the example of FIG. 9) may be presented to the user with the following gray level values: 8, 16, 24, and 32. In other words, the rows of “zeros,” “ones,” “twos,” and “threes” may have gray levels of 8, 16, 24, and 32, respectively. As the rows of dark gray elements are displayed, the user is instructed to set brightness and contrast of the display device to maximum, using the analog or digital controls provided with the display device. The user is then further instructed to reduce the brightness of the display device until the row with the darkest (lowest gray level value) elements is barely visible, and then click “next” upon completion (132). This optional step of display device adjustment serves to prepare the monitor for the blackpoint determination carried out with respect to each color channel, as described below.

To carry out the blackpoint determination process for each color channel, several rows (or columns) of elements for each color channel may be displayed on successive web pages. Specifically, red channel, blue channel, and green channel web pages for channel-specific blackpoint determination can be served to the client in any order. In each case, the elements for a given color channel may be arranged in rows in ascending order of relative lightness or darkness, as in web page 128 of FIG. 9, which is served for display device adjustment. The rows provide a sequence of gray level gradations. The bottom row for the red channel blackpoint determination web page, for example, may be a row of “zeros” having elements bearing the darkest shade (lowest gray value) of red among the elements shown on the web page. As with web page 128, arrangement of the elements in rows or columns is for purposes of illustration. In some embodiments, display of a series of individual elements (rather than rows of elements) may suffice.

The row of darkest elements that is barely visible to the user will depend on the blackpoint for the respective channel of the display device. The rows of elements are displayed against a black, i.e., RGB=0, background. With some display devices, the user may be unable to see elements with intensity levels of 8, 16, or higher. The user is instructed to select the row of elements that is barely visible on the display device. This step determines the blackpoint, i.e., the visible “cut-off” point at which further decreases at which further decreases in the color channel value produce no further decreases in light emitted by the display device for that color channel. As an alternative, the user could be prompted to make the least visible row of elements vanish for a given color channel and then click on the remaining barely visible bar. In either case, the blackpoint can be estimated.

FIG. 10 illustrates a web page 134 for use in blackpoint determination in a color profiling process as shown in FIG. 8. Web page 134 may be substantially similar to web page 128 of FIG. 6. For example, web page 134 may include rows 136 of shaded elements. Again, display of columns of elements or a series of elements may be sufficient for some applications. As shown in FIG. 10, web page 134 instructs the user to select the row of elements that is barely visible on the display device. As in web page 128, the rows 136 in web page 134 may be arranged as rows of “zeros,” “ones,” “twos,” and “threes” having, for example, intensity levels of 8, 16, 24, and 32, respectively. Web page 134 in FIG. 10 represents the web page for red channel blackpoint determination, and includes rows of red elements set against a black background.

Upon selection of the row that is barely visible for the red channel, e.g., upon clicking on any element in the row, the user is automatically served a substantially identical web page containing rows of green elements set against a black background for purposes of determining the green channel blackpoint. Following selection of a row of green elements that is barely visible, a substantially identical web page for blue channel blackpoint determination is served to the user and the user makes a similar selection. Thus, successive web pages governing blackpoint determination for each color channel can be served automatically following selection of a row for a preceding channel. Alternatively, the user may be prompted to click on a “next” icon or similar device. Serving successive web pages automatically following selection of an element may be desirable, of course, to reduce the overall number of clicks involved in the process.

In the above manner, the user selects the row of elements that is barely visible for each color channel, and thereby provides an indication of the blackpoint for each color channel. FIG. 8 further illustrates the process. In particular, FIG. 8 shows the display of rows of dark red elements or characters (110), and selection of the row that is barely visible (112), and further illustrates the computation of the estimated blackpoint for the red channel based on the selected row (114). Alternatively, the blackpoint can be computed later based on the selection. Similarly, for the green channel, a row of dark green characters is displayed (116), followed by selection of the row that is barely visible (118), and computation of an estimated blackpoint for the green channel based on the selected row (120). Finally, for the blue channel, a row of dark blue characters is displayed (122), followed by selection of the row that is barely visible (124), and computation of an estimated blackpoint for the blue channel based on the selected row (126).

Following selection of the barely visible row of elements displayed on each successive web page, the pertinent client 14 transmits the result to color profile server 18. Alternatively, the results for all color channels can be transmitted at the same time following completion of the blackpoint determination for the last color channel. Color profile server 18 then may compute the estimated blackpoint for each channel or simply store the parameters for later computation, e.g., by color imager server 18.

The complete description of the display device behavior can be represented by the following equation which relates RGB to XYZ:

$$[ \begin{matrix}X \\ Y \\ Z\end{matrix} ] = [ \begin{matrix}{X}_{r , max} & {X}_{g , max} & {X}_{b , max} \\ {Y}_{r , max} & {Y}_{g , max} & {Y}_{b , max} \\ {Z}_{r , max} & {Z}_{g , max} & {Z}_{b , max}\end{matrix} ] [ \begin{matrix}R \\ G \\ B\end{matrix} ]$$

$$where$$

$$R = \{ \begin{matrix}{[ ( {d}_{r} - {k}_{o , r} ) / ( 1.0 - {k}_{o , r} ) ]}^{{γ}_{r}} , & [ ( {d}_{r} - {k}_{o , r} ) / ( 1.0 - {k}_{o , r} ) ] \geq 0 \\ 0 & [ ( {d}_{r} - {k}_{o , r} ) / ( 1.0 - {k}_{o , r} ) ] < 0\end{matrix} \}$$

$$G = \{ \begin{matrix}{[ ( {d}_{g} - {k}_{o , g} ) / ( 1.0 - {k}_{o , g} ) ]}^{{γ}_{g}} , & [ ( {d}_{g} - {k}_{o , g} ) / ( 1.0 - {k}_{o , g} ) ] \geq 0 \\ 0 & [ ( {d}_{g} - {k}_{o , g} ) / ( 1.0 - {k}_{o , g} ) ] < 0\end{matrix} \}$$

$$B = \{ \begin{matrix}{[ ( {d}_{b} - {k}_{o , b} ) / ( 1.0 - {k}_{o , b} ) ]}^{{γ}_{b}} , & [ ( {d}_{b} - {k}_{o , b} ) / ( 1.0 - {k}_{o , b} ) ] \geq 0 \\ 0 & [ ( {d}_{b} - {k}_{o , b} ) / ( 1.0 - {k}_{o , b} ) ] < 0\end{matrix} \}$$

The variables dᵣ, d_{g}, and d_{b} are the digital input values for the red, green, and blue channels, normalized to 1.0. The parameters k_{o,r}, k_{o,g}, and k_{o,b}, are the blackpoints and the parameters γᵣ, γ_{g}, and γ_{b} are the gammas for the red, green, blue channels.

The values of parameters k_{o,r}, k_{o,g}, and k_{o,b}, are determined as follows: Assume that (regardless of the properties of a particular monitor) for the red channel there exists a minimal visible set of values for XYZ that can be detected by the human eye, designated as the vector (X_{t,r},Y_{t,r},Z_{t,r}). This vector will have a unique corresponding value for R in the expression above, designated as Rₜ. For a particular monitor with specific values of γᵣ and k_{o,r} there will be a unique device value associated with Rₜ which is designated by d_{t,r}:

$${R}_{t} = \{ \begin{matrix}{[ ( {d}_{t , r} - {k}_{o , r} ) / ( 1.0 - {k}_{o , r} ) ]}^{{γ}_{r}} , & [ ( {d}_{t , r} - {k}_{o , r} ) / ( 1.0 - {k}_{o , r} ) ] \geq 0 \\ 0 & [ ( {d}_{t , r} - {k}_{o , r} ) / ( 1.0 - {k}_{o , r} ) ] < 0\end{matrix} \}$$

This device value d_{t,r} is determined by the user during the color profiling procedure as described, i.e., by selecting the darkest barely visible row of elements in the blackpoint determination web page for red. The value of Rₜ is empirically determined. For example, for a calibrated display system in a dark room with k_{o,r}=0.0 and γᵣ=2.2, a red patch may be visible for d_{t,r}=8/255 gray levels which implies Rₜ=(8/255)^{2.2}.

The exact value of k_{o,r} can be calculated by solving two simultaneous equations, namely the equation above for Rₜ and the equation for R_{0.33} which will be described below. Alternatively, a reasonable estimate can be made for ko,r by assuming a gamma of 2.2. If this assumption is made, the value of k_{o,r} can be estimated as:

$${R}_{t} = {( \frac{8.0}{255.0} )}^{2.2} = {[ ( {d}_{t , r} - {k}_{o , r} ) / ( 1.0 - {k}_{o , r} ) ]}^{2.2}$$

$$( \frac{8.0}{255.0} ) = [ ( {d}_{t , r} - {k}_{o , r} ) / ( 1.0 - {k}_{o , r} ) ] \approx {d}_{t , r} - {k}_{o , r}$$

$${k}_{o , r} = {d}_{t , r} - ( \frac{8.0}{255.0} )$$

In a similar fashion, the values for k_{o,g} and k_{o,b,} can be determined.

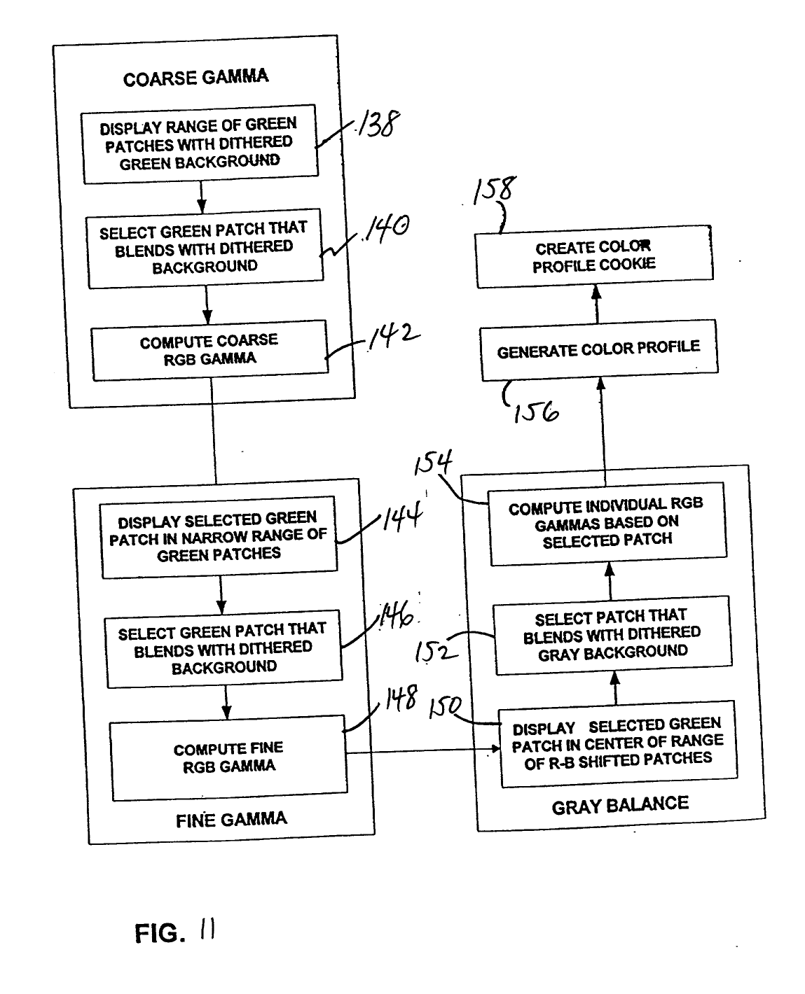

FIG. 11 is a flow diagram illustrating gamma and gray balance determination in a color profiling process. For determination of coarse gamma, one of the web pages served by color profile server 18 displays a range of green elements, e.g., patches, against a dithered green background (138). The coarse gamma determination web page can be served immediately and automatically following selection of a row of elements in the last blackpoint determination web page, or in response to selection of a “next” icon or similar device.

In one embodiment, the coarse gamma determination is limited to only the green color channel. Specifically, the coarse gamma determination is made using a series of green elements against a green dithered background. Green is the most dominant and intense phosphor among red, green, and blue, and is highest in contrast. Green also has the highest L*. Note also that green most closely matches the photopic V(λ) response of the eye. This approach to coarse gamma determination considers only the green color channel, and essentially ignores red and blue.

In this manner, the coarse gamma measurement concentrates on the most dominant color channel and avoids errors that can arise due to the red-blue imbalances that are highly prevalent in many display devices. Thus, the elements displayed for the coarse gamma determination may be green patches with different darkness or lightness values. Alternatively, a combined coarse gamma for all of the color channels may be determined as described in the above-referenced U.S. patent application Ser. No. 09/631,312.

Upon display of the green patches, the user is instructed to select a patch that appears to most closely blend with the dithered background (140). The green patch “blends” with the dithered background in the sense that it appears to closely match the level of the background. An example of a range of green patches displayed against a green dithered background is shown in FIG. 12 and indicated by reference numeral 160. This range of green patches and the green dithered background can be displayed in a web page served by color profile server 18. Based on the selected green patch, which again may be selected by clicking on it with a pointing device, color profile server 18 computes a coarse gamma (142). The coarse gamma determined in this step can be used as an estimate for the average gamma of R, G, and B via selection of a green patch from the set of green patches against the dithered green background. The dithered green background may be set at approximately 25% to 50%. Dithered backgrounds approaching approximately 33% may more closely match the actual midpoint of black to green transition for the display device, and may be preferred for typical display devices.

By alternating black and green at an appropriate frequency, a 25%, 33%, or 50% green background can be produced. For a CRT, turning on or off all of the pixels in a given horizontal line should produce more predictable output from display device to display device than modulating individual pixels to form vertical lines, due to the video bandwidth of the device. For flat panel devices, this is less of an issue. To accommodate clients using both CRT's and flat panel devices, however, generation of the dithered background by use of alternating horizontal lines is preferred.

The center patch in the range 160 of patches can be based on an average gamma of 2.0, since most monitors range from 1.6 to 2.5. The other green patches that surround the center patch may proceed in a sequence with relatively large steps, e.g., 8 gray levels apart from one another. Coarse gamma can be estimated using the equation:

G_{0.33}=0.333 =[(d_{0.33,g}−k_{o.g})/(1.0−k_{o.g})]^{γ}_{g}

where d_{0.33,g} is the gray level value (normalized to 1.0) of the selected patch that appears to most closely blend in with the background, k_{o,g} is the previously determined blackpoint, G_{0.33} is the relative intensity of the green channel (equal to ⅓), and γ_{g} is the green gamma. As an alternative to actually computing the coarse gamma, the green level value of the selected patch simply is carried forward for use in the fine gamma process. In this case, the value can eventually be discarded.

After the coarse gamma estimate is obtained, fine gamma is estimated. Fine gamma is a refined or “fine-tuned” estimate for the average gamma of R, G, and B. Fine gamma can be determined by selection of another green patch from a set of green patches presented against a dithered green background. In this case, the center patch may be identical to the green patch selected by the user for determination of coarse gamma. Thus, the coarse gamma step “informs” the fine gamma step. In effect, the selected coarse gamma patch may serve as a starting point for the fine gamma determination. Specifically, the green patch selected in the coarse gamma determination can be used as the central patch for the fine gamma determination.

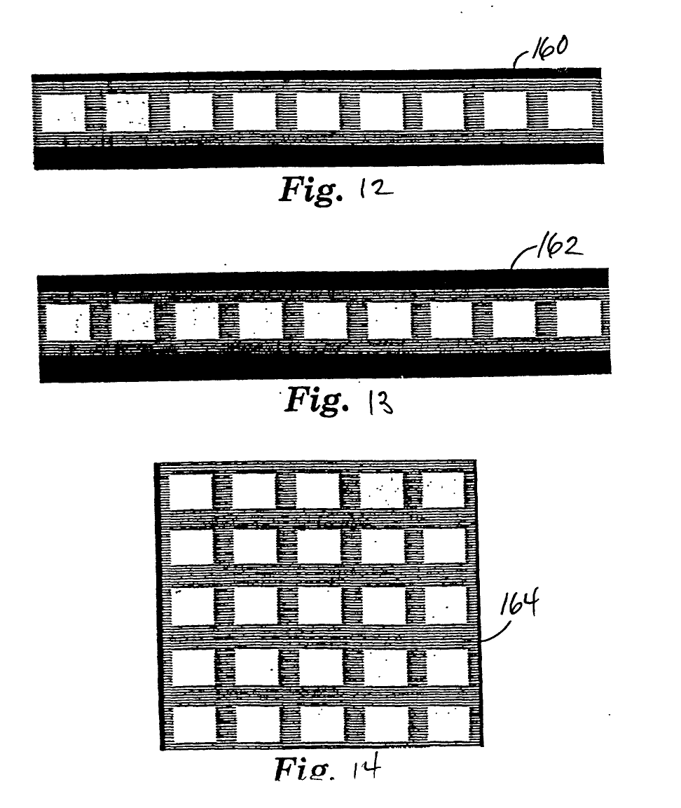

A range of patches for determining fine gamma is illustrated in FIG. 13 and designated by reference numeral 162. The patches in this range are in a sequence with smaller steps centered about the center green patch selected in the coarse gamma process. For example, the patches may be set at 4 green levels apart, in contrast to the 8 green levels used as the difference for the coarse gamma determination. In this manner, a narrower range is used to “fine-tune” the coarse gamma estimate, with the center of the range having been “learned” from the coarse gamma estimate.

A web page served by color profile server 18 displays the selected green patch from the coarse gamma estimate among a narrower range of green patches (144). The user then is instructed to select the green patch that most closely blends with the same dithered green background as used for coarse gamma (146). Based on the selected patch, color profile server 18 computes a single fine RGB gamma (148). Thus, the fine gamma is the overall gamma estimated for the RGB channels. Alternatively, as mentioned above, the RGB value of the selected patch can simply be stored for use by color image server 16 in computing fine gamma and rendering color corrections. In any event, a refined estimate for gamma can be computed according to the equation:

G_{0.33}=0.333=[(d_{0.33,g}−k_{o.g})/(1.0−k_{o.g})]^{γ}_{g}

where d_{0.33,g} is the green level value (normalized to 1.0) of the selected patch that blends in with the background, k_{o,g} is the previously determined blackpoint, G_{0.33} is the relative intensity of the green channel (equal to ⅓), and γ_{g} is the green gamma.

To determine gray balance, color profile server 18 serves a web page that displays a plurality of RGB patches. The RGB patches can be generated with the same value of green selected in the previous fine gamma step in conjunction with values of red and blue that are substantially equal to or systematically shifted from the previously selected value of green. The RGB patches can be displayed against a gray background which is dithered in the same manner as the green dithered background of the previous step (fine gamma) (150). Again, this step “learns” from the previous one, and forms part of a cascading series of color profiling steps (coarse gamma, fine gamma, and gray balance) that help narrow the search for the correct gamma. The user is then instructed to select the gray patch that appears to most closely blend with the dithered background (152). Based on the selected gray patch, individual RGB gammas are computed (154). Notably, the overall gray balance determination can be made with a single click of the user's pointing device.

Thus, in this gray balance process, the green intensity value selected in the fine gamma process is used to generate the gray patches that exhibit +/− (plus/minus) differences or “shifts” in red and blue about the value of the gray patch. For example, the value of green selected in the fine gamma process can be displayed in the center of the range in conjunction with substantially identical values of red and blue. In this case, the gamma is initially assumed to be the same for each color channel. The gammas for red and blue are then fine tuned by the gray balance determination, which helps identify red-blue imbalance in the display device. Thus, the green gamma is “locked in” in the gray balance step, while the red and blue imbalance is determined. In other words, every patch in the gray balance array carries the same green value, but is modulated by different gradations of red and blue. This step eliminates one axis of variation, green, but permits identification of any imbalance between red and green and blue and green. This limits the range of choices to a more finely-tuned area, and aids the user in making a more accurate selection.

The range of patches for the gray balance determination may be a two-dimensional array of patches with red-blue-shifted patches arranged around the central gray patch formed according to the gamma estimate from the fine gamma process. In other embodiments, the red channel could be used to determine the initial RGB gamma estimate, followed by a gray balance determination that resolves imbalance between green and red or blue and red.

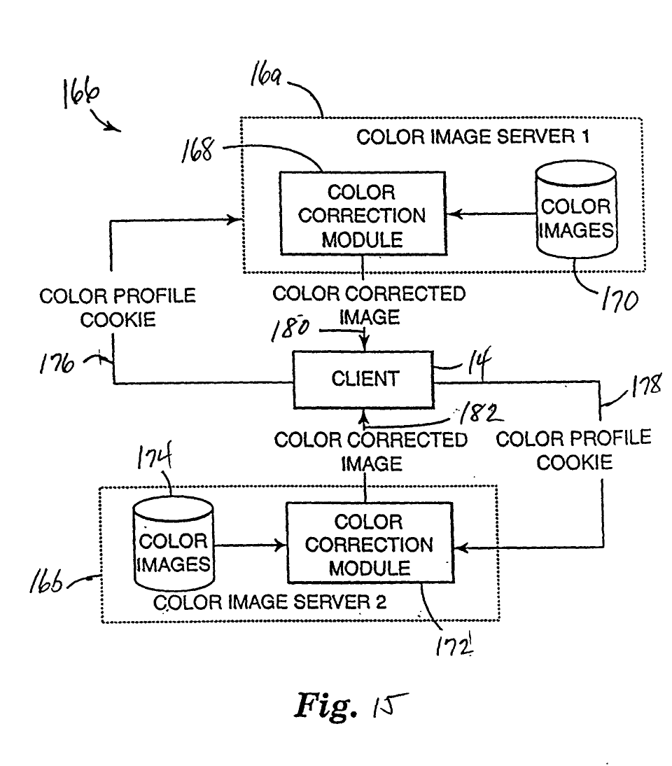

FIG. 14 illustrates an example of a two-dimensional range 164 of gray patches arranged in a five-by-five matrix for use in the gray balance determination. Each patch represents a shift away from the central gray patch along either the blue axis, the red axis, or a combination of both, but preferably does not represent any further green shift. The user selects the patch that appears to most closely blend with the dithered gray background, which may be a 33 % dithered background. The central patch can optionally be highlighted to indicate it is the preferred default choice.

The number of patches and the exact values of RGB for each patch can be quite flexible. For example, in the case of the image in FIG. 14, all patches can be selected to have identical values of L* as indicated by the estimated profile for the display based on phosphors, average gamma, and blackpoint. Patches adjacent to the center may differ by all permutations of +/−3 ΔE for a* and for b* as estimated from a Matrix TRC (tone reproduction curve) profile constructed from the above parameters.

Patches around the outer perimeter of the grid array may differ from the center by +/−6 ΔE in R and B. Alternatively, for simplicity, one can elect to vary R and B only by +/− a fixed amount such as +/−5 gray levels and +/−10 gray levels. Preferably, all patches are relatively small deviations from the central patch in all directions of color space of approximately constant L*. This test will help determine in a sensitive manner whether there exists a significant difference in the gammas of R, G, and B, and thereby expose significant gray imbalance between G and R or G and B.

The two-dimensional format of the patches shown in FIG. 14 may aid the user's selection of the correct patch. The patch from the previous step in the color profiling process, i.e., fine gamma, is placed at the center in this embodiment. Adjacent patches differ in gray level as the array extends outward such that the outer periphery of the array contains patches that are two gradations removed from the central patch. The array produces a visual “funnel” effect that, from experience, tends to direct the user toward the central patch as the starting point for matching with the background. The differences between patches in the two-dimensional array are more clear and dramatic than in a one-dimensional strip of patches. As the array extends outward, the shift becomes greater. Thus, the gradations are well pronounced and aid the user in picking the appropriate patch which, in many cases, will be the central patch selected in the previous step of the color profiling process.

If the user selects the central patch, a single gamma value is used for the R, G, and B channels. If one of the other patches are selected, three separate gammas are calculated based on the equations:

R_{0.33}=0.333=[(d_{0.33,r}−k_{o,r})/(1.0−k_{o,r})]^{γ}ᵣ

B_{0.33}=0.333=[(d_{0.33,b}−k_{o,b})/(1.0−k_{o,b})]^{γ}_{b}

where the subscripts for γ and d_{0.33} indicate unique values for the R and B channels. The values for d_{0.33} for each channel are given by the values of RGB of the particular patch selected in this gray balance step. These equations are combined with a set of phosphor values to generate accurate profiles for the client's display device, using equations well known in the art, and referred to as Matrix TRC formalism in the International Color Consortium (ICC) specification. Again, calculations can be performed by color profile server 18 or by a color correction module associated with color image server 16.

The process of selecting patches in the coarse gamma, fine gamma, and gray balance determination steps is advantageous because, in preferred embodiments, it requires no applications, applets, or other client-side scripts to be loaded at the client side. Rather, the user may simply select one of the patches displayed in a web page. In other embodiments, however, if applications, applets, or client-side scripts are used, it is conceivable that smooth slider bars, +/− arrows, and the like could be used to adjust the color of a single patch in real-time for comparison to the dithered background. In this manner, the user has the ability to precisely match a single patch to the background, rather than select from a finite set of patches the one that most closely matches. This technique of real-time adjustment also may be useful for non-networked approaches to color calibration and characterization. In this case, for blackpoints, gamma, and/or gray balance, the patch or element selected by the user may be a single adjustable patch in a condition in which the slider or other adjustment medium has adjusted its color to a level that is visually acceptable to the user, i.e., to a point at which the patch appears to match the dithered background.

Based on the blackpoint, coarse gamma, fine gamma, and gray balance processes, a color profile for the display device is generated (156). Upon generation of the color profile, a color profiler cookie is created (158). Information representative of the color profile is added to the color profiler cookie for future use. In particular, the information can be used to create an image server cookie for future interaction between the particular client 14 and the particular web server 12 and color image server 16. Although the color profile is especially useful for characterizing display devices in a network, it also may be useful in a non-networked application. In particular, the color profiling process described herein may find ready use in the calibration and characterization of an individual display device for correction of content generated or obtained locally with the device, rather than across a network.

Advantageously, there is no need for the client 14 to provide information regarding the configuration of its display device. Very satisfactory results can occur using an average set of phosphor values based on published standards such as sRGB, Apple Macintosh RGB, and the like. If desired, further steps can be added, particularly in order to address the issue of phosphor values and white point. The color profiling process simply results in generation of a cookie that serves as a container and vehicle for passing information characterizing the color response of the display device associated with client 14 to color image server 16. Alternatively, the chromaticity information and white point can in some cases be obtained from the display utilizing communication protocols such as VESA and/or from the operating system of the computer. The usefulness of this invention will continue because, with current technology, the RGB blackpoints and gammas are difficult to maintain perfectly at the hardware level even with expensive electronic circuitry.

Ordinarily, all cookies visible to a particular domain are attached to each request from a browser application executed by a client 14. For this reason, a typical browser limits each domain to a maximum of twenty cookies. To avoid consuming the allotment of cookies for a particular web site, all of the color correction information for a particular client 14 preferably is packed into a single profiler cookie and a single image server cookie. For example, a number of items can be packed into the value string of the image server cookie or the profiler cookie, as the case may be. In particular, each cookie should include the gamma values for R, G, and B. Each gamma value may be a value between 1.0 and about 3.0. In addition, the cookie may include the chromaticity values for black and white, e.g., expressed as a value between 0 and +1000.0.

An exemplary cookie may have the following items packed into its value string, each demarcated by a separator:

(1) Cookie format version code—a numeric code, e.g., 1 to 3 bytes, plus separator.

(2) Cookie installation date—the usual cookie-style timestamp (milliseconds after midnight of Jan. 1, 1970, GMT), e.g., 12 to 13 bytes, plus separator.

(3) Unique profiler ID assigned to this color information when it is generated by the color correction sequence; a long integer, e.g., 4 bytes, plus separator (but possibly longer).

(4) Gamma and blackpoint values for R, G, B—each a text representation of a floating-point value between 1.0 and about 3.0, retaining 4 decimal digits. The decimal point could be implied. Thus, the gamma values may take up 5 or 6 bytes plus a separator each, or three times that overall. Alternatively, the selected tint values chosen for R, G, and B can be indicated, enabling the gamma and blackpoint values to be calculated at a later time by a server upon upload of the cookie.

(5) Chromaticity for Black and White—each a text representation of a floating-point value between 0 and +1000.0, retaining 4 significant digits. Thus, this may take up 6 or 7 bytes plus a separator each, or two times that overall.

(6) Number of bits per color—two decimal digits: two bytes plus separator.

(7) Display Device ID code—an alphanumeric code, which may be roughly 10 bytes plus separator.

(8) Cookie Data Checksum—a long integer: 4 bytes.

The example cookie described above has about 68 bytes plus 10 separators. The separator character should be chosen so that the string does not have to be “escaped”; the caret (ˆ ) is frequently used this way. Thus, the typical size for the value string may be about 80 bytes.

FIG. 15 is block diagram illustrating transmission of color correction information in a system as shown in FIGS. 1 and 2. In particular, FIG. 15 illustrates a system 166 in which image server cookies have already been created for two different color image server 16a, 16b accessed by an individual client 14. In this case, upon accessing a web page from a web server 12, client 14 requests images from color image server 16a. When requesting images from another web server 12, client 14 requests images from color image server 16b. Color image server 16a incorporates both a color correction module 168 and an archive 170 of color images. Similarly, color image server 16b includes a color correction module 172 and an archive 174 of color images.

When client 14 sends an image request to color image server 16a, it sends along a color profile cookie, i.e., an image server cookie, as indicated by line 176. Likewise, as indicated by line 178, client 14 sends an image server cookie to color image server 16b when requesting an image. In each case, the image server cookie contains a color profile that provides color correction information for use by the respective color correction module 168, 170 in modifying, i.e., color correcting, the color images served from image archives 172, 174, respectively. Thus, when a request is received, color images server 18a or 18b processes the accompanying image server cookie to extract the contents, and controls the respective color correction module 168, 170 based on the extracted contents. In this manner, client 14 receives color corrected images, as indicated by reference numerals 180, 182.

The manner in which color correction modules make use of the color profiles contained in the image server cookies will now be described. In the embodiment described with reference to FIGS. 8-14, blackpoints for each color channel are estimated based on red, green, and blue elements selected by a user associated with a respective client 14. Thus, the output of the color profiling process is a blackpoint RGB value and a gamma, or individual RGB gammas. Now we assume that these values have been determined in the manner described above. The complete description of the display device behavior can be given by the following equation which relates RGB→XYZ:

$$[ \begin{matrix}X \\ Y \\ Z\end{matrix} ] = [ \begin{matrix}{X}_{r , max} & {X}_{g , max} & {X}_{b , max} \\ {Y}_{r , max} & {Y}_{g , max} & {Y}_{b , max} \\ {Z}_{r , max} & {Z}_{g , max} & {Z}_{b , max}\end{matrix} ] [ \begin{matrix}R \\ G \\ B\end{matrix} ]$$

$$where$$

$$R = \{ \begin{matrix}{[ ( {d}_{r} - {k}_{o , r} ) / ( 1.0 - {k}_{o , r} ) ]}^{{γ}_{r}} , & [ ( {d}_{r} - {k}_{o , r} ) / ( 1.0 - {k}_{o , r} ) ] \geq 0 \\ 0 & [ ( {d}_{r} - {k}_{o , r} ) / ( 1.0 - {k}_{o , r} ) ] < 0\end{matrix} \}$$

$$G = \{ \begin{matrix}{[ ( {d}_{g} - {k}_{o , g} ) / ( 1.0 - {k}_{o , g} ) ]}^{{γ}_{g}} , & [ ( {d}_{g} - {k}_{o , g} ) / ( 1.0 - {k}_{o , g} ) ] \geq 0 \\ 0 & [ ( {d}_{g} - {k}_{o , g} ) / ( 1.0 - {k}_{o , g} ) ] < 0\end{matrix} \}$$

$$B = \{ \begin{matrix}{[ ( {d}_{b} - {k}_{o , b} ) / ( 1.0 - {k}_{o , b} ) ]}^{{γ}_{b}} , & [ ( {d}_{b} - {k}_{o , b} ) / ( 1.0 - {k}_{o , b} ) ] \geq 0 \\ 0 & [ ( {d}_{b} - {k}_{o , b} ) / ( 1.0 - {k}_{o , b} ) ] < 0\end{matrix} \}$$

The variables dᵣ, d_{g}, and d_{b} are the digital input values normalized to 1.0. The parameters k_{o,r}, k_{o,g}, and k_{o,b}, are the blackpoints for the red, green, and blue channels, and the parameters γᵣ, γ_{g}, and γ_{b} are the gammas for the red, green, blue channels. Thus, the gamma and blackpoint information contained in the image server cookie for a respective display device can be used in the above equations to produce, in effect, a color profile. The color profile can be used to perform a transformation of the image data sufficient to produce calibrated output on the display device.

The above approach is different than other attempts to characterize display devices such as equation 21 in Berns, “CRT Colorimetry. Part I: Theory and Practice.”In most characterizations, the “k” parameters are used to describe black offset rather than blackpoint. Black offset refers to the non-zero intensity measured or perceived from a display for RGB=0. In our experience, the contrast/brightness adjustment procedure used in a color profiling process in accordance with embodiments of this invention minimizes the effect of this phenomenon. However, non-zero blackpoints are very possible even after the contrast/brightness adjustment, and therefore should be taken into account.

This profile description can either be used in this format or converted to formats such as those specified by the ICC. This format is also known as the Matrix TRC format, and utilizes a generic lookup table for the expressions above for R, G, and B rather than an equation combined with a matrix similar to above. The above information, e.g., gammas, blackpoints, and the like, can be stored in a cookie on a computer associated with a client 14. Alternatively, the individual data which are the RGB values of the patches selected by the user can be stored in the cookie, which can permit improved profile technology to be employed at a later date utilizing the same input information.

To implement a system as described herein with an existing archive of images and HTML codebase for a web site, the existing web server 12 is modified to replace existing image file references indicated in HTML pages with similar references to a pertinent color image server 16 equipped with a color correction module. For example, an existing subscriber image file reference called:

http://www.SubscriberName.com/images/ImageName.jpg

could be replaced with:

http://correction.SubscriberName.com/images/ImageNamejpg.

These modified references in the HTML page then issue a command to the color image server 16 to serve the requested image. When the color image server 16 receives the command, it also receives the image server cookie, if one exists, and applies the information contained in the cookie to perform color correction. The color image server 16 then reads the pertinent image file, creates a unique display profile utilizing the display parameters stored in the image server cookie, and converts the image from before sending it to the client's browser.

All images stored on the web server 12 may have a corresponding copy file of the same name residing on the subscriber color image server 16. The color image server 16 may access this database of image files to read, convert, and send images referenced by the HTML page sent to the client 14. According to one embodiment, color image server 16 may use a very simple and quick technique for color management. In particular, all images on the color image server 16 preferably have a predetermined RGB color space. This typically means that original images are converted from the color space of corresponding devices, e.g., such as scanners, digital cameras, and the like, to the standard color space determined by a particular web site. Good examples of standard RGB color spaces are ColorMatch RGB, which has a color temperature for the “virtual display” of D50. Other color spaces such as Adobe RGB have an excellent gamut, but have a color temperature of D65. When an image on an HTML page sent to the client 14 is referenced via the color image server 16 associated with a web server 12 such as:

correction.SubscriberName.com/images/ImageName.jpg

color image server 16 accesses the corresponding image and converts the RGB data in real time before sending the image to the client destination. The conversion can be performed according to the following calculation:

$${R}_{s} = \{ \begin{matrix}{[ ( {d}_{r , s} - {k}_{o , r , s} ) / ( 1.0 - {k}_{o , r , s} ) ]}^{{γ}_{r , s}} , & [ ( {d}_{r , s} - {k}_{o , r , s} ) / ( 1.0 - {k}_{o , r , s} ) ] \geq 0 \\ 0 & [ ( {d}_{r , s} - {k}_{o , r , s} ) / ( 1.0 - {k}_{o , r , s} ) ] < 0\end{matrix} \}$$

$${G}_{s} = \{ \begin{matrix}{[ ( {d}_{g , s} - {k}_{o , g , s} ) / ( 1.0 - {k}_{o , g , s} ) ]}^{{γ}_{g , s}} , & [ ( {d}_{g , s} - {k}_{o , g , s} ) / ( 1.0 - {k}_{o , g , s} ) ] \geq 0 \\ 0 & [ ( {d}_{g , s} - {k}_{o , g , s} ) / ( 1.0 - {k}_{o , g , s} ) ] < 0\end{matrix} \}$$

$${B}_{s} = \{ \begin{matrix}{[ ( {d}_{b , s} - {k}_{o , b , s} ) / ( 1.0 - {k}_{o , b , s} ) ]}^{{γ}_{b , s}} , & [ ( {d}_{b , s} - {k}_{o , b , s} ) / ( 1.0 - {k}_{o , b , s} ) ] \geq 0 \\ 0 & [ ( {d}_{b , s} - {k}_{o , b , s} ) / ( 1.0 - {k}_{o , b , s} ) ] < 0\end{matrix} \} \\ [ \begin{matrix}{R}_{c} \\ {G}_{c} \\ {B}_{c}\end{matrix} ] = {[ \begin{matrix}{X}_{r , c , max} & {X}_{g , c , max} & {X}_{b , c , max} \\ {Y}_{r , c , max} & {Y}_{g , c , max} & {Y}_{b , c , max} \\ {Z}_{r , c , max} & {Z}_{g , c , max} & {Z}_{b , c , max}\end{matrix} ]}^{- 1} [ \begin{matrix}{X}_{r , s , max} & {X}_{g , s , max} & {X}_{b , s , max} \\ {Y}_{r , s , max} & {Y}_{g , s , max} & {Y}_{b , s , max} \\ {Z}_{r , s , max} & {Z}_{g , s , max} & {Z}_{b , s , max}\end{matrix} ] [ \begin{matrix}{R}_{s} \\ {G}_{s} \\ {B}_{s}\end{matrix} ]$$

$${d}_{r , c} = {k}_{o , r , c} + ( 1.0 - {k}_{o , r , c} ) {min ( 1.0 , {R}_{c} )}^{1 / {γ}_{r , c}}$$

$${d}_{g , c} = {k}_{o , g , c} + ( 1.0 - {k}_{o , g , c} ) {min ( 1.0 , {G}_{c} )}^{1 / {γ}_{g , c}}$$

$${d}_{b , c} = {k}_{o , b , c} + ( 1.0 - {k}_{o , b , c} ) {min ( 1.0 , {B}_{c} )}^{1 / {γ}_{b , c}}$$

Note that the matrices above can be concatenated into a single matrix for increased processing speed.

As an alternative architecture, all images for various web sites may be stored at a central color image server 16. Color profile server 18 may reside or be integrated with color image server 16 in such an embodiment. In this case, color profiling server 18 provides web pages for guidance of a color profiling process as described herein. Color image server 16 or color profile server 18 may include a database server for storage of individual color profiles associated with client 14. When a client 14 requests an image tagged in the code sent by one of web servers 12, it is directed to the central color image server 16. The color image server 16 may use a client ID sent from the client to retrieve the appropriate color profile and apply it to modify the requested color image using techniques as described herein for color correction. In this manner, color image server 16 provides color corrected images without the need for transfer of cookies and the like between client 14 and the color image server.

A number of embodiments of the present invention have been described. Nevertheless, it will be understood that various modifications may be made without departing from the spirit and scope of the invention. Accordingly, other embodiments are within the scope of the following claims.

1. A method comprising:
formulating a text file containing color commands for presentation of objects within a web page based on a color response of a display device associated with a client on a computer network; and
communicating the text file via the computer network.

2. The method of claim 1, further comprising specifying a color value in the text file based on the color response of the display device.

3. The method of claim 2, further comprising:
communicating the web page to the client; and
setting a color of one of the objects in the web page based on the color value in the text file.

4. The method of claim 3, wherein setting a color of an object comprises setting at least one of a text color, a background color, a color of a table cell, and a color of a region of the web page.

5. The method of claim 3, further comprising:
setting a color of an image tagged in the web page based on the color response of the display device associated with the client; and
communicating the tagged image to the client.

6. The method of claim 5, further comprising:
generating a color profile based on the color response of the display device;
formulating the text file based on the color profile; and
setting the color of the image based on the color profile.

7. The method of claim 5, further comprising:
communicating the web page from a first server; and
communicating the tagged image from a second server.

8. The method of claim 5, further comprising:
communicating the web page from a first server; and
communicating the text file from a second server.

9. The method of claim 1, further comprising characterizing the color response of the display device by guiding the client through a color profiling process.

10. The method of claim 9, further comprising guiding the client through the color profiling process by delivering one or more color profiling web pages to the client.

11. The method of claim 9, further comprising:
generating a web cookie for the client containing information representing a result of the color profiling process; and
communicating the web cookie to a server that communicates the text file.

12. The method of claim 11, further comprising formulating the text file at the server based on the contents of the web cookie.

13. The method of claim 12, further comprising:
communicating to the client an image tagged in the web page; and
setting the color of the image at the server based on the contents of the web cookie.

14. The method of claim 13, further comprising:
communicating the web page to the client from a first server;
storing the text file and the tagged image on a second server;
communicating the tagged image to the client from the second server; and
communicating the color profiling web pages to the client from a third server.

15. The method of claim 1, further comprising:
communicating web pages to multiple clients on a computer network; and
formulating customized text file for the web pages based on the color responses of display devices associated with each of the clients.

16. A computer-readable medium containing instructions that cause a programmable processor to:
formulate a text file containing color commands for presentation of objects within a web page based on a color response of a display device associated with a client on a computer network; and
communicate the text file via the computer network.

17. The computer-readable medium of claim 16, wherein the instructions cause the processor to specify a color value in the text file based on the color response of the display device.

18. The computer-readable medium of claim 16, wherein the instructions cause the processor to:
communicate the web page to the client; and
set a color of an object in the web page based on the color value in the text file.

19. The computer-readable medium of claim 18, wherein the instructions cause the processor to set a color of an object by setting at least one of a text color, a background color, a color of a table cell, and a color of a region of the web page.

20. The computer-readable medium of claim 18, wherein the instructions cause the processor to:
set a color of an image tagged in the web page based on the color response of the display device associated with the client; and
communicate the tagged image to the client.

21. The computer-readable medium of claim 20, wherein the instructions cause the processor to:
generate a color profile based on the color response of the display device;
formulate the text file based on the color profile; and
set the color of the image based on the color profile.

22. The computer-readable medium of claim 20, wherein the instructions cause the processor to:
communicate the web page from a first server; and
communicate the tagged image from a second server.

23. The computer-readable medium of claim 20, wherein the instructions cause the processor to:
communicate the web page from a first server; and
communicate the text file from a second server.

24. The computer-readable medium of claim 20, wherein the instructions cause the processor to characterize the color response of the display device by guiding the client through a color profiling process.

25. The computer-readable medium of claim 24, wherein the instructions cause the processor to guide the client through the color profiling process by delivering one or more color profiling web pages to the client.

26. The computer-readable medium of claim 24, wherein the instructions cause the processor to:
generate a web cookie for the client containing information representing a result of the color profiling process; and
communicate the web cookie to a server that communicates the text file.

27. The computer-readable medium of claim 26, wherein the instructions cause the processor to formulate the text file at the server based on the contents of the web cookie.

28. The computer-readable medium of claim 27, wherein the instructions cause the processor to:
communicate to the client an image tagged in the web page; and
set the color of the image at the server based on the contents of the web cookie.

29. The computer-readable medium of claim 28; wherein the instructions cause the processor to:
communicate the web page to the client from a first server;
store the text file and the tagged image on a second server;
communicate the tagged image to the client from the second server; and
communicate the color profiling web pages to the client from a third server.

30. The computer-readable medium of claim 16, wherein the instructions cause the processor to:
communicate web pages to multiple clients on a computer network; and
formulate customized text files for the web pages based on the color responses of display devices associated with each of the clients.

31. A system comprising a color correction module that formulates a text file containing color commands for presentation of objects within a web page for a web page based on a color response of a display device associated with a client on a computer network.

32. The system of claim 31, further comprising:
a first server that communicates the web page to the client; and
a second server that communicates the text file to the client.

33. The system of claim 32, wherein the color correction module runs on the second server.

34. The system of claim 32, wherein the color correction module runs on a third server.

35. The system of claim 31, wherein the color correction module specifies a color value in the text file based on the color response of the display device.

36. The system of claim 31, wherein the client executes a web browser that sets a color of an object in the web page based on the color value in the text file.

37. The system of claim 36, wherein the web browser sets a color of an object by setting at least one of a text color, a background color, a color of a table cell, and a color of a region in the web page.

38. The system of claim 31, further comprising:
a first server that communicates the web page to the client; and
a second server that communicates to the client an image tagged in the web page,
wherein the color correction module sets a color of the image based on the color response of the display device.

39. The system of claim 38, further comprising:
a color profile server that generates a color profile based on the color response of the display device,
wherein the color correction module formulates the text file based on the color profile, and sets the color of the image based on the color profile.

40. The system of claim 31, further comprising a color profile server that characterizes the color response of the display device by guiding the client through a color profiling process.

41. The system of claim 40, wherein the color profile server guides the client through the color profiling process by delivering one or more color profiling web pages to the client.

42. The system of claim 41, further comprising a cookie server that generates a web cookie for the client containing information representing a result of the color profiling process.

43. The system of claim 42, wherein the color correction module formulates the text file based on the contents of the web cookie.

44. The system of claim 42, further comprising an image server that communicates to the client an image tagged in the web page, wherein the color correction module sets the color of the image based on the contents of the web cookie.

45. The system of claim 31, further comprising:
a web server that communicates the web page to the client,
an image server that stores the text file and one or more images tagged in the web page, and a color profile server; and
a color profile server that characterizes the color response of the display device by guiding the client through a color profiling process.

46. The system of claim 31, further comprising a web server that communicates web pages to multiple clients on the computer network, wherein the color correction module formulates customized text file for the web pages based on the color responses of display devices associated with each of the clients.
